(19) United States
(12) Patent Application Publication
(10) Pub. No.: US 2026/0303618 A1
(43) Pub. Date: Oct. 1, 2026

(54) MITIGATION OF SECURITY EVENTS UTILIZING ARTIFICIAL INTELLIGENCE AGENTS

(71) Applicant: Microsoft Technology Licensing, LLC, Redmond, WA (US)

(72) Inventors: Maor NISSAN, Herzliya (IL); Roee OZ, Tel Aviv (IL); Tamer SALMAN, Haifa (IL); Andrey KARPOVSKY, Kiryat Motzkin (IL); Fady COPTY, San Jose, CA (US); Tamara GAIDAR, Tirat Carmel (IL)

(21) Appl. No.: 19/094,310

(22) Filed: Mar. 28, 2025

(51) Int. Cl. H04L 9/40; H04L 41/16

(52) U.S. Cl. CPC H04L 63/1416; H04L 41/16

(57) ABSTRACT

Systems, methods, devices, and computer readable storage media described herein for mitigation and remediation of security events. In an aspect, a first artificial intelligence (AI) agent selects a candidate for remediating a security event based at least on event information related to a security event detected with respect to a computing network and candidate data identifying candidates of the computing network. A second AI agent generates a remediation task for remediating the security event and assigns the remediation task to the selected candidate. A third AI agent monitors performance of the remediation task and detects if the selected candidate fails to remediate the security event. In a further aspect, the first AI agent selects the candidate based on a similarity between the security event and another security event previously remediated by the candidate. In another aspect, the second AI agent generates the remediated task based on the previously remediated event.

### BACKGROUND

Computing network systems implement security detection and mitigation tools to detect exposure of sensitive data or other compromises in the integrity of the system. A service team member is assigned a task to remediate a security vulnerability or exposure. The time to identify the member, assign the task to the member, and for the member to perform the task can be cumbersome. Identifying a human orchestrator or manual orchestrator operated by a human can take a long time to identify an appropriate team member to handle a task. Furthermore, once a task is assigned, manual monitoring of the assigned member's performance is at risk of human error.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments described herein are related to remediating security events in networked computing systems. In an aspect, event information related to a security event is received. Candidate data identifying candidate users or automated components is received. A candidate is selected from among the candidate users and/or automated components based on the event information and the candidate data. A remediation task for remediating the security event is generated based on the selected candidate and the event information. The remediation task is assigned to the selected candidate. Performance of the remediation task is monitored. If the candidate fails to remediate the security event, a mitigation step is performed to mitigate the failure.

In a further aspect, a system utilizes artificial intelligence (AI) agents to select the candidate, generate the remediation task, and monitor performance of the task.

Other implementations are also described herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for remediating security events, in accordance with an example embodiment.

FIG. 2 shows a block diagram of a system for remediating security events, in accordance with another example embodiment.

FIG. 3 shows a flowchart of a process for remediating security events, in accordance with an example embodiment.

FIG. 4A shows a flowchart of a process for performing a mitigating step, in accordance with an example embodiment.

FIG. 4B shows a flowchart of a process for performing a mitigating step, in accordance with another example embodiment.

FIG. 4C shows a flowchart of a process for performing a mitigating step, in accordance with another example embodiment.

FIG. 5 shows a block diagram of a system comprising the candidate search agent of FIG. 1, according to an example embodiment.

FIG. 6 shows a flowchart of a process for automatically selecting a candidate for remediating a security event, in accordance with an example embodiment.

FIG. 7 shows a flowchart of a process for automatically selecting a candidate for remediating a security event, in accordance with an example embodiment.

FIG. 8 shows flowchart of a process for obtaining event embeddings of a previously remediated security event, in accordance with an example embodiment.

FIG. 9 shows a flowchart of a process for candidate selection and validation, in accordance with an example embodiment.

FIG. 10 shows a block diagram of a system comprising the remediation agent of FIG. 1, according to an example embodiment.

FIG. 11 shows a flowchart of a process for generating a remediation task, in accordance with an example embodiment.

FIG. 12 shows a flowchart of a process for generating a remediation task, in accordance with another example embodiment.

FIG. 13 shows a flowchart of a process for generating a remediation task, in accordance with another example embodiment.

FIG. 14 shows a flowchart of a process for assigning a remediation task, in accordance with an example embodiment.

FIG. 15 shows a block diagram comprising the monitoring agent of FIG. 1, according to an example embodiment.

FIG. 16 shows a flowchart of a process for detecting whether or not a security event has been mitigated and responding to the detection, in accordance with an example embodiment.

FIG. 17 shows a flowchart of a process for automatically tagging a candidate, in accordance with an example embodiment.

FIG. 18 shows a block diagram of a system for remediating security events utilizing automated remediators, in accordance with an embodiment.

FIG. 19 shows a flowchart of a process for remediating security events utilizing automated remediators, in accordance with an embodiment.

FIG. 20 shows a block diagram of an example computing environment in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Security Event Remediation Utilizing AI Agents

Computing network systems, such as enterprise network systems or cloud computing systems, implement security detection and mitigation techniques to detect security events with respect to the system. Example security events include, but are not limited to, exposure of sensitive data, a backdoor in an application, a compromised resource, a failure in a firewall or other automatic security system, anomalous behavior by a user computing device or service of the system, and/or other compromises or irregularities in the system. When a new security event is detected, a service team member is typically tasked with selecting and implementing a response strategy. In some existing scenarios, a security administrator selects which team member or members are going to handle the response. A security administrator may determine which tasks are to be implemented and which members are to perform which tasks. A security administrator can also divide tasks into sub-tasks and distribute the work among multiple members. The security administrator can assign a tick within a ticketing system that associates a member and a task, allowing progress to be tracked. A security officer often makes calls, sends messages or e-mails, guesses, or manually discusses assignments when assigning tasks. This is time consuming and can result in an assignment of a task to an incorrect team member—e.g., a team member that lacks the appropriate skills or access level, a team member that has an overloaded backlog, a team member that is otherwise unavailable, and/or the like. Assigning a task to an incorrect team member results reassessment and assignment of tasks, which can reduce the time to implement response strategies. The longer a security team takes in addressing a security event, the more time a malicious entity has to leverage a vulnerability in the system.

As threats made by cyber-attacks and malicious entities such as hackers grow more complex and frequent, existing techniques are put under increased stress to remedy vulnerabilities. Security officers have to coordinator greater numbers of task and other information in assigning tasks to remediate events and team members are placed on tighter schedules to perform tasks. Furthermore, manual review of security events further lengthens the time to determine and assign tasks. Still further, a security officer and other members of the security team have to consider strategies to remediate security events without disrupting legitimate business activity or in a manner that has a reduced disruption on legitimate business activity. As organizations and their computing networks grow, the complexity in managing security also increases. More computing devices, applications, virtual resources, data, and users can result in a difficult system to navigate or implement solutions to security events. One solution is to increase the number of members in a security team, where different members handle implementing security measures with respect to different parts of an organization's computing network, implementing different types of security measures, and/or otherwise distribute the workload of the security team for a computing network system. However, the security officer still has to determine which security team member is an appropriate person to handle a given task.

Issues in identifying appropriate security team members or tasks to be performed can be further exacerbated where an owner of a resource (e.g., the creator of the resource, an assigned user of the resource, and/or the like) impacted by the security event is not familiar with a current state of the resource and/or its usage. For instance, a user can have several resources assigned to them or created by them, but they may not actively track all of the resources. Moreover, a user's focus can shift as they work on different projects or tasks. This shift and spread of attention can limit how much a user can assist in identifying or describing a problem in their system.

In order to automate at least a portion of service team member selection and assignment of tasks, some implementations utilize heuristic models that locate a relevant person using existing data (such as activity on a resource or existing permissions in a user-assets graph). These heuristic approaches can decrease the time required to find a person. However, an output of a heuristic model can be approximate or have issues if no relevant person is found due to a lack of activity or permissions. Furthermore, in some cases, the suggested person can be incorrect or lead to a dead end. Existing heuristic model implementations are also typically passive approaches that provide suggestions without live validation or resolution capabilities.

Aspects of the present disclosure provide artificial intelligence (AI) agents that assign and monitor tasks for remediating security events. An AI agent is a component implemented in software, hardware, or hardware combined with software and/or firmware that utilizes AI to automatically take actions and perform tasks. In an aspect, agents for assigning and monitoring tasks perform operations with respect to selecting a candidate team member for remediating a security event, generating a task for remediation a security event, and monitoring performance of the remediation task. For example, a system for assigning and monitoring tasks can include a candidate search agent that selects a candidate, a remediation agent that generates a remediation task, and a monitoring agent that monitors performance of the task; however, additional agents for performing different tasks can be implemented. In an aspect, a system utilizing AI agents identifies candidates associated with a computing network system impacted by a security event. The system utilizes an AI agent to select a candidate from among the identified candidates for remediating the security event. The system utilizes an AI agent to generate a remediation task the selected candidate is to perform to attempt to remediate the security event. The system further utilizes an AI agent to automatically monitor performance of the remediation task, detect failure to remediate the security event, and mitigate detected failures. By leveraging AI agents in this manner, the systems described herein decrease the time to select a candidate for remediating a security event, decrease the time to determine a task to remediate a security event, and increase the accuracy in selecting candidates and generating remediation tasks. By reducing the time to select a candidate and determine a task, embodiments decrease the time from when a security event is detected to when a security event is remediated, thereby decreasing the risk a security event poses to the exposed resource or computing network system. Furthermore, by automatically monitoring task performance and mitigating detected failures, embodiments can further reduce the time to remediate a security vulnerability in situations where a selected candidate fails to remediate a task.

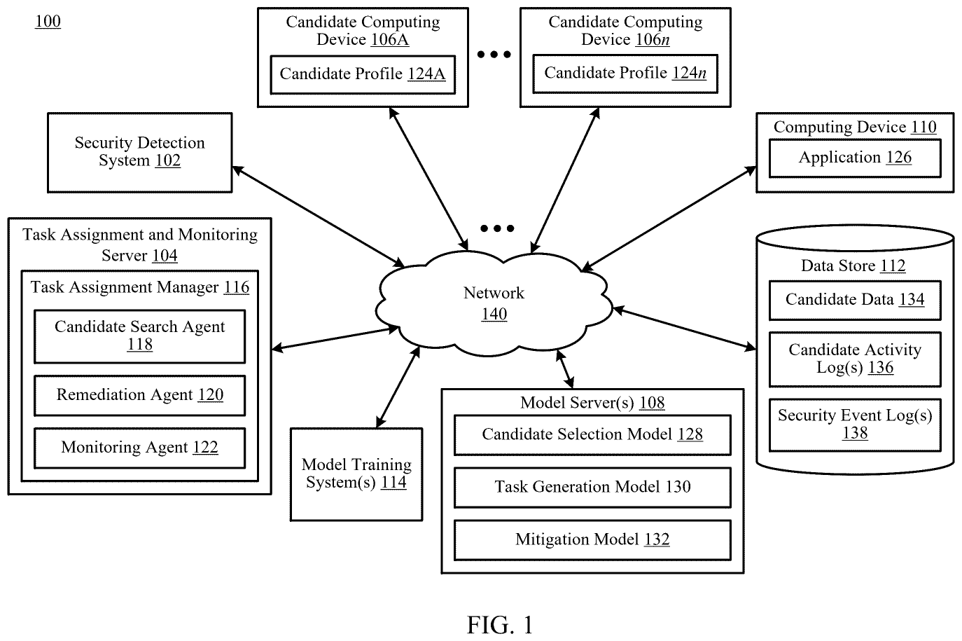

Embodiments for assigning and managing tasks for remediating security events can be configured in various ways. For example, FIG. 1 shows a block diagram of a system 100 for mitigating security events, in accordance with an example embodiment. As shown in FIG. 1, system 100 comprises a security detection system 102, a task assignment and monitoring server 104, a plurality of candidate computing devices 106A and 106n (collectively “computing devices 106A-106n” herein), one or more model servers 108 (also referred to as “model server 108” herein), a computing device 110, a data store 112, and one or more model training systems 114 (also referred to as “model training system 114” herein). In an embodiment, security detection system 102, task assignment and monitoring server 104, computing devices 106A-106n, model server 108, computing device 110, data store 112, and model training system 114 are coupled via a network 140. In examples, network 140 comprises one or more networks such as local area networks (LANs), wide area networks (WANs), enterprise networks, the Internet, etc. In examples, network 140 comprises one or more wired and/or wireless portions. In a non-limiting example, some or all of security detection system 102, task assignment and monitoring server 104, computing devices 106A-106n, model server 108, computing device 110, data store 112, model training system 114 and/or network 140 are comprised within a network system, such as a cloud network system, an enterprise network system, and/or another network system. In some examples, a network system is associated with the same tenant of a cloud network, the same organization of an enterprise network, and/or the like. Alternatively or additionally, one or more of security detection system 102, task assignment and monitoring server 104, computing devices 106A-106n, model server 108, computing device 110, data store 112, model training system 114 are implemented by a third party (e.g., a third party organization, a managing company, a security organization, an information technology (IT) organization, and/or the like). The features of system 100 are described in detail as follows.

In examples, candidate computing devices 106A-106n and computing device 110 are any type of stationary or mobile processing device, including, but not limited to, a desktop computer, a server, a mobile or handheld device (such as a tablet, a personal data assistant (PDA), a smart phone, a laptop, etc.), an Internet-of-Things (IoT) device, etc. In accordance with an embodiment, candidate computing devices 106A-106n and computing device 110 are associated with respective users (such as an individual user, a group of users, an organization, a family user, a customer user, an employee user, an admin user (such as a service team user, a developer user, a management user, etc.), etc.). For instance, in a non-limiting example, computing device 110 is associated with an employee user of an enterprise network and candidate computing devices 106A-106n are associated with respective service team users or management users of the enterprise network. In another non-limiting example, computing device 110 is associated with a member of a tenant of a cloud computing network and candidate computing devices 106A-106n are associated with respective service team users of the tenant, management users of the tenant, service team users of a cloud service provider of the cloud computing network, developer users of the cloud service provider, and/or the like.

In embodiments, a user of candidate computing devices 106A-106n and/or computing device 110 can have a user profile that is used to manage the user's access to data, services, other hardware, and/or the like. A user profile can specify a username that identifies the user, demographic information of the user, the user's name, an organization a user belongs to, a manager of the user, a team within the organization the user belongs to, other members of the team, a user's role in the organization, a user's physical address, a user's current location, one or more privileges granted to the user, registered skills of the user, applications or tools the user has registered with, and/or other information associated with the user and their profile. In an embodiment, user profile data is stored on the computing device. For example, candidate computing device 106A stores data for a candidate profile 124A of an associated user and candidate computing device 106n stores data for a candidate profile 124n. Alternatively or additionally, candidate profile data is stored in a data store (e.g., data store 112).

In embodiments, candidate computing devices 106A-106n and computing device 110 are configured to execute applications. For instance, as shown in FIG. 1, computing device 110 executes an application 126. Application 126 is any type of application for performing operations on computing device 110 or within a network system. Examples of application 126 include, but are not limited to, word processing applications, code development applications, workload applications, network communication applications, cloud network interface applications, data management applications, web browsers, security system applications, debugging applications, and/or any other type of application executable by computing device 110. In an implementation where computing device 110 is a device of an enterprise network, application 126 is a web application accessible to computing devices within the enterprise network, an application made available to some or all users of the enterprise network, or an application with a license granted with respect to the enterprise network or otherwise associated with the enterprise network. In an implementation where computing device 110 is a device of a tenant within a cloud network, application 126 is an application accessible to some or all users of the tenant via the cloud network, an application with a license granted to some or all users of the tenant, an application installed from the cloud network, and/or the like. In accordance with an embodiment, application 126 enables a user of, a component of, or another application executed by computing device 110 to interface with security system 102, task assignment and monitoring server 104, candidate computing devices 106A-106n, model server 108, data store 112, and/or model training system 114. While not shown in FIG. 1, candidate computing devices 106A-106n can also execute applications similar to application 126. For instance, in an embodiment where a user associated with candidate computing device 106A is a code developer, candidate computing device 106A can execute a code development application, a debugging application, and/or the like.

Data store 112 is implemented as any type of physical storage device, including but not limited to, storage disks, solid-state drives (SSDs), random access memory (RAM) devices, flash memory, digital video disks, and/or other types of physical/tangible hardware storage media. Data store 112 is configured to store data utilized by and/or generated by security detection system 102, task assignment and monitoring server 104, candidate computing devices 106A-106n, model server 108, computing device 110, and/or model training system 114. For instance, as shown in FIG. 1, data store 112 stores candidate data 134, one or more candidate activity logs 136 (“candidate activity logs 136 herein), and one or more security event logs 138 (“security event logs 138” herein). Data store 112 is shown as separate from security detection system 102, task assignment and monitoring server 104, candidate computing devices 106A-106n, model server 108, computing device 110, and model training system 114. Alternatively, data store 112 is implemented as a component (e.g., in a memory device) of one or more of security detection system 102, task assignment and monitoring server 104, candidate computing devices 106A-106n, model server 108, computing device 110, and/or model training system 114.

As stated above, data store 112 stores candidate data 134. Candidate data 134 comprises data regarding candidate users of candidate computing devices 106A-106n. In an example, candidate data 134 comprises data of candidate profiles such as candidate profile 124A and 124n. In an embodiment, candidate data 134 is stored in a data structure such as an organizational chart that identifies information such as, but not limited to, names of employees in an organization, roles of the employees, a managerial hierarchy, groupings of employees (e.g., departments, teams, projects, etc.), and/or other information related to the organization and its employees. In another example, candidate data 134 comprises a graph-based data structure comprising nodes that correspond to employees and resources of the organization and edges interconnecting nodes of the graph-based data structure, the edges representing a relationship between nodes. For instance, in an embodiment, an edge interconnects a first node corresponding to candidate profile 124A and a second node corresponding to a development tool of an organization. In this example, the edge indicates candidate profile 124A has access to the development tool. In another embodiment, a group of edges interconnects a first node corresponding to a license of the organization and respective second nodes corresponding to candidate profiles. In this example, the edges indicate the candidate profiles are granted the license. In implementations where candidate data 134 comprises a graph-based data structure, application or device can access the graph to retrieve information pertaining to a node such as information comprised within the node, edges connected to the node, other nodes connected to the node via edges, and/or the like.

As also shown in FIG. 1, data store 112 can store log files such as, but not limited to candidate activity logs 136 and security event logs 138. Candidate activity logs 136 comprise records of operations a candidate user has performed utilizing their respective candidate computing device or other devices associated with the candidate user profile within system 100. Example operations an activity log of candidate activity logs 136 can record include, but are not limited to, account login operations, logout operations, failed login attempts, accesses to data, modifications made to data, executions of applications, operations performed utilizing an application, database operations, errors encountered during execution of applications and/or database operations, elevated privilege requests, and/or other operations a candidate user has performed by interaction with their respective candidate user computing device or another computing device associated therewith. In an implementation, a service can access one or more logs of candidate activity logs 136 to audit or otherwise monitor user activity.

Security event logs 138 comprise records of operations and other information associated with a security event. In an embodiment, a security event log is created by security detection system 102 subsequent to, as part of, or otherwise with respect to detection of a security event. A security event log can comprise data collected through monitoring an ongoing security event, such as monitoring operations of computing devices and/or applications associated with the security event. In another implementation, a security event log can comprise previously generated records (such as activity logs, system logs, error logs, and/or the like) security detection system 102 associates with a detected security event. Example information within a security event log includes, but is not limited to, an identifier of a security event, resources impacted by the security event, user accounts impacted by the security event, a potential or identified point of entry associated with the security event, a timestamp of when the security event was detected, a date or timestamp that the security event was determined to begin, data utilized to detect the security event, a candidate user assigned to remediate the security event, activity of the candidate user performed with respect to the security event, operations executed as part of the security event, remediation tasks performed with respect to the security event, whether or not the security event has successfully been remediated, and/or any other information associated with the security event. In an implementation, a service can access one or more logs of security event logs 138 to determine the status of a security event or otherwise monitor the security event.

Security detection system 102 is a computer implemented system configured to detect security events within system 100. Security detection system 102 can comprise one or more servers or other computing devices. In an implementation, security detection system 102 comprises one or more hardware-implemented monitoring devices utilized to monitor activity within a system. In an implementation, security detection system 102 is a security system of an enterprise network computing device 110 is associated with. In another implementation, security detection system 102 is a cloud security system of a cloud network computing device 110 is associated with. In either case, security detection system 102 detects security events with respect to computing device 110 and/or other computing devices within the network, applications executed by one or more of the computing devices, and/or the like. Security detection system 102 can detect security events in a variety of ways. For instance, in an embodiment, security detection system 102 detects a security event based on an error occurring in execution of an application, execution of an operation, or an error in another action performed with respect to a computing device monitored by security detection system 102. In another example, security detection system 102 detects security event by determining activity in an activity log, transaction log, and/or the like is anomalous. In a further example, activity is determined anomalous when a level of similarity between the activity and previously identified anomalous activity (e.g., previous data breaches, previous system errors, other previous security events, and/or the like) satisfies a threshold. For instance, if monitored activity comprises performance of the same type of access attempt operations as a previous security event, security detection system 102 can flag the monitored activity as a security event. In another example, security detection system 102 detects irregularities in resource utilization that match or fall within a predetermined range of utilization as irregular resource utilization during a previous security event. In this example, security detection system 102 flags the irregular resource utilization as a security event. Security detection system 102 generates a security event log responsive to detecting a security event. The security event log comprises records of activity associated with the security event and/or other information associated with the security event, as described elsewhere herein.

Task assignment and monitoring server 104 and model server 108 are network-accessible servers or other types of computing devices. In accordance with an embodiment, one or more of task assignment and monitoring server 104 and model server 108 are incorporated in a network-accessible server set (such as a cloud-based environment, an enterprise network server set, and/or the like). In an embodiment, and as shown in FIG. 1, task assignment and monitoring server 104 and model server 108 are separate servers. In an alternative example embodiment, task assignment and monitoring server 104 and/or model server 108 are implemented across multiple servers or computing devices (such as in a distributed server implementation) or integrated in a single server. In an implementation, task assignment and monitoring server 104 and model server 108 are incorporated in the same server or group of servers. Each of task assignment and monitoring server 104 and model server 108 are configured to execute services and/or store data. For instance, as shown in FIG. 1, task assignment and monitoring server 104 executes a task assignment manager 116 and model server 108 executes/stores a candidate selection model 128, a task generation model 130, and a mitigation model 132. In an embodiment, application 126 (or an application of candidate computing devices 106A-106n not shown in FIG. 1 for brevity) interfaces with task assignment manager 116, candidate selection model 128, task generation model 130, and/or mitigation model 132.

As stated above, task assignment and monitoring server 104 executes a task assignment manager 116. Task assignment manager 116 is a computer-implemented service, component, or combination of services and components. Task assignment manager 116 is configured to receive security event information, assign a candidate for remediating a security event, generating a remediation task for remediating the security event, and monitoring performance of the remediation task. As shown in FIG. 1, task assignment manager 116 comprises a candidate search agent 118, a remediation agent 120, and a monitoring agent 122 (collectively referred to as “agents 118-122” herein). In an embodiment, agents 118-122 are AI-driven agents. In this context, agents 118-122 leverage generative AI models to perform their respective operations. In an implementation, agents 118-122 utilize separate generative AI models to perform their respective operations. Alternatively, two or more of agents 118-122 utilize the same generative AI model to perform their respective operations.

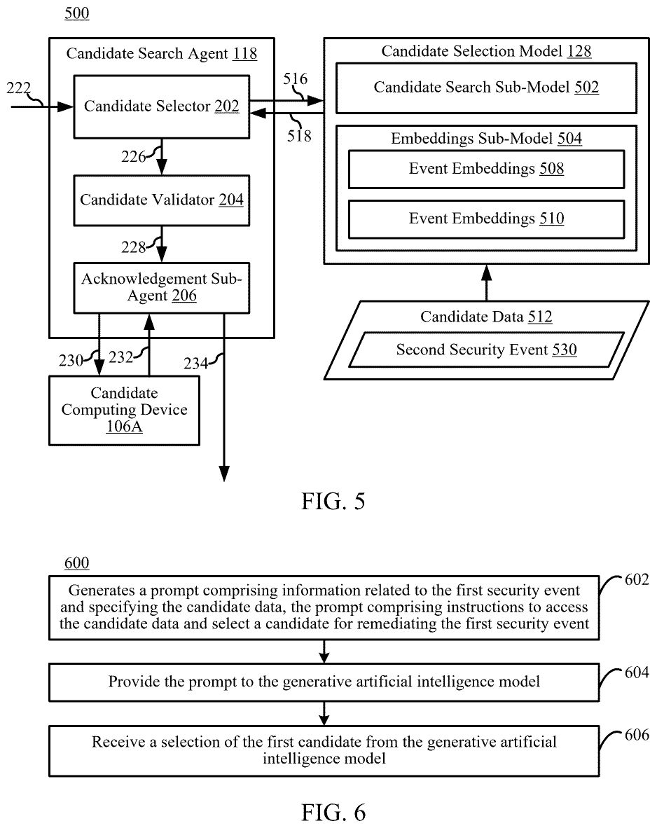

Candidate search agent 118 comprises logic for receiving information describing a security event, selecting a candidate for remediating the security event, validating the selected candidate, communicating with a candidate computing device corresponding to the selected candidate, and/or other operations related to searching for candidate(s) for remediating security events. For example, candidate search agent 118 can select a candidate from among candidates corresponding to candidate computing devices 106A-106n for remediating a security event detected by security detection system 102. Depending on the implementation, candidate search agent 118 selects the candidate from among a plurality of candidates based on a level of similarity between the detected security event and a past security event previously remediated by the candidate satisfying a similar event criterion, based on a task backlog of the candidate satisfying a task availability criterion, based on a tag of the detected security event matching a tag of a candidate profile of the candidate, based on privileges of the candidate, based on a role of the candidate, based on a relationship of the candidate to a user of a user account impacted by the security event, and/or based on other information associated with the security event, the candidate, and/or the system impacted by the security event. In accordance with an embodiment, candidate search agent utilizes candidate search model 128 of model server 108 to search for a candidate. Additional details regarding searching for candidates utilizing candidate search model 128 are described with respect to FIGS. 5-8, as well as elsewhere herein.

In some embodiments, candidate search agent 118 validates the selected candidate as a selection for remediating the security event. Validation steps can include transmitting a communication to a computing device of the selected candidate indicating an intention to assign the candidate for remediating the security event and receiving a response from the candidate accepting the assignment, verifying permissions of the candidate, verifying availability of the candidate, and/or other steps for validating candidates described elsewhere herein. If the candidate is a valid selection, the task assignment and monitoring process continues. If the candidate is an invalid selection, candidate search agent 118 selects a new candidate from among the plurality of candidates. Additional details regarding validating candidates are described with respect to FIGS. 5 and 9, as well as elsewhere herein.

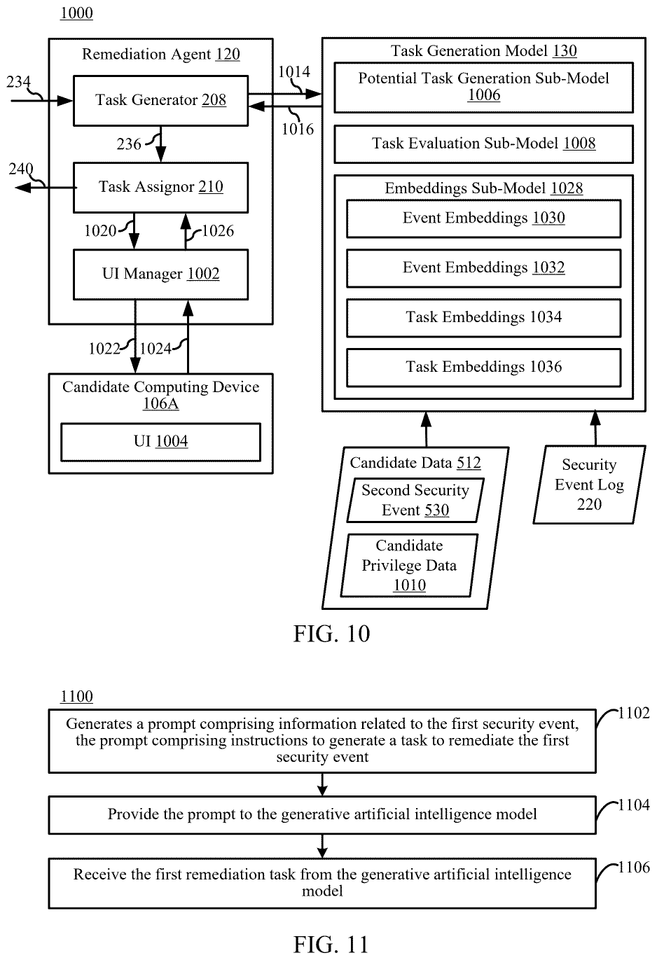

Remediation agent 120 comprises logic for generating tasks for remediating security events (also referred to herein as “remediation tasks”) and assigning remediation tasks to candidates. In embodiments, remediation agent 120 generates a task based on event information related to the security event detected by security detection system 102 and the candidate selected by candidate search agent 118. For instance, remediation agent 120 can generate a remediation task based on a role of the selected candidate, a tool available to the selected candidate, a level of privileges of the selected candidate, data or other resources the selected candidate has access to, an application or other service the candidate utilizes, a skill attributed to the selected candidate, a previous remediation task performed with respect to a previous security event, a previous remediation task performed with respect to the security event, a previous remediation task assigned with respect to the security event, a resource or account impacted by the security event, and/or other information related to the selected candidate or the security event. In an embodiment, remediation agent 120 accesses candidate data 134, candidate activity logs 136, and/or security event logs 138 to generate the remediation task. In accordance with an embodiment, remediation agent utilizes task generation model 130 of model server 108 to generate a remediation task. Additional details regarding generating remediation tasks utilizing task generation model 130 are described with respect to FIGS. 10-13, as well as elsewhere herein.

Remediation agent 120 can generate a variety of remediation tasks. Example remediation tasks include, but are not limited to, a task to change privileges of an impacted resource or account, a task to restart an impacted resource or other device or service, a task to disable an impacted resource or other device or service, a task to deploy a patch or other update to a resource or other device or service, a task to reset credentials of a user account or service account, and/or a task to perform another operation with respect to the security event, an impacted resource, or other resources of the system. Remediation agent 120 can generate the remediation task by generating natural language instructions, query language, code or other output. For instance, in an example, remediation agent 120 generates a remediation task by generating a code patch for remediation an error or vulnerability in code of an application. In another example, remediation agent 120 generates a set of natural language instructions for manual, semiautomatic, or automatic implementation of the remediation task. In another example, remediation agent 120 generates a query language query to be executed by a query engine (not shown in FIG. 1 for brevity) for remediating the security event. In an embodiment, remediation agent 120 generates a plurality of tasks. Depending on the implementation, remediation agent 120 can select a recommendation from among the plurality of tasks, select multiple remediation tasks of the plurality to be performed (e.g., in a specified order, in a recommended order, or in any order), and/or the like.

Remediation agent 120 also comprises logic for assigning the remediation task to a candidate. For instance, in an example, remediation agent 120 transmits a recommendation of the remediation task or instructions for performing the remediation task to a candidate computing device of candidate computing devices 106A-106n corresponding to the selected candidate. In an example, a candidate is able to respond to the recommendation or instructions indicating whether or not the candidate accepts the task. If so, the process of generating a remediation task is complete. If not, remediation agent 120 generates an alternative remediation task, presents an alternative remediation task, or causes a new candidate to be selected. Additional details regarding assigning remediation tasks are described with respect to FIGS. 10 and 14, as well as elsewhere herein. In some embodiments, remediation agent 120 causes some or all of a remediation task to be performed automatically (e.g., subsequent to or as part of assigning the remediation task). For instance, in an embodiment, remediation agent 120 determines a sub-steps of a remediation task that can be performed automatically based on an organization policy of the organization the security event is impacting. As a non-limiting example, suppose the organization policy specifies task assignment manager 116 is allowed to reset credentials of user accounts if a security event is detected with respect to the user account. In this example, remediation agent 120 automatically causes the credentials of the user account to be reset. By automatically performing a subset of a remediation tasks, remediation agent 120 is able to reduce or prevent further impact on resources by the security event without waiting for a candidate to perform the remediation task. Furthermore, automatically performing the subset of a remediation task reduces the number of actions a candidate computing device has to take in order to remediate the security event, thereby offloading processing cycles from the selected candidate computing device.

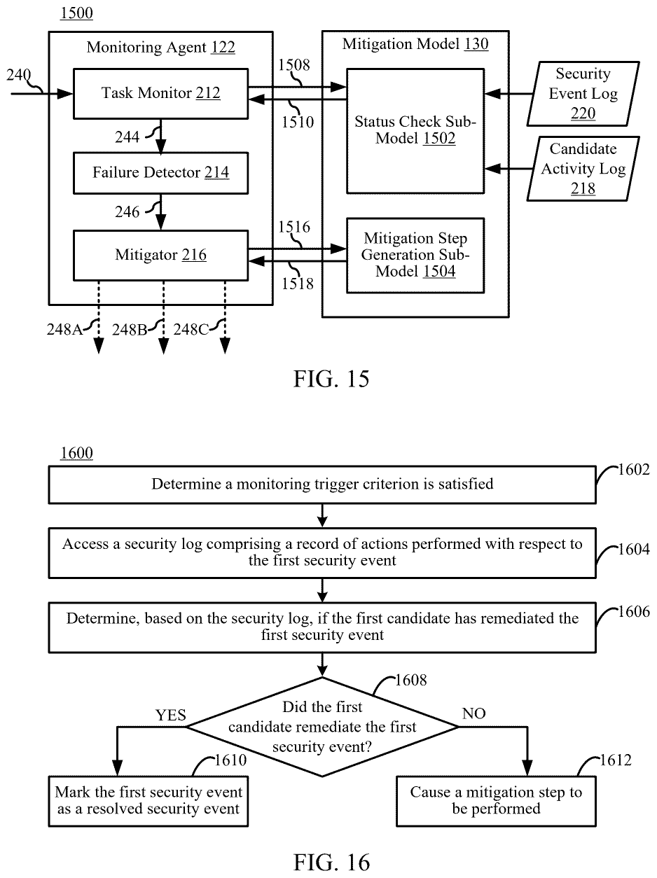

Monitoring agent 122 comprises logic for monitoring performance of a remediation task, detecting failure in performance of the remediation task, and mitigating the detected failure. For example, monitoring agent 122 monitors the remediation task that remediation agent 120 assigns to a candidate selected by candidate search agent 118. In an implementation, monitoring agent 122 monitors the task by accessing a log of candidate activity logs 136 corresponding to the selected candidate. In another implementation, monitoring agent 122 monitors the task by accessing a log of security event logs 138 corresponding to the detected security event. In an embodiment, monitoring agent 122 determines whether or not a remediation task was successfully performed based on the monitoring. In an embodiment, monitoring agent 122 determines remediation of a security event was unsuccessful based on a period of time since the task was assigned satisfying a time limit threshold. In an aspect, if the time limit threshold is met or exceeded, monitoring agent 122 determines if the task has been performed and, if so, clears the task from monitoring. If not, monitoring agent 122 causes a mitigation step to be performed. In another embodiment, monitoring agent 122 determines remediation of a security event was unsuccessful based on completion of a remediation task. If the remediation task successfully remediated the security event, the task is cleared from monitoring. If not, monitoring agent 122 causes a mitigation step to be performed. In accordance with an embodiment, monitoring agent 122 utilizes mitigation model 132 of model server 108 to determine if a security event has been remediated. Additional details regarding determining if a security event has been remediated utilizing mitigation model 132 are described with respect to FIGS. 15 and 16, as well as elsewhere herein.

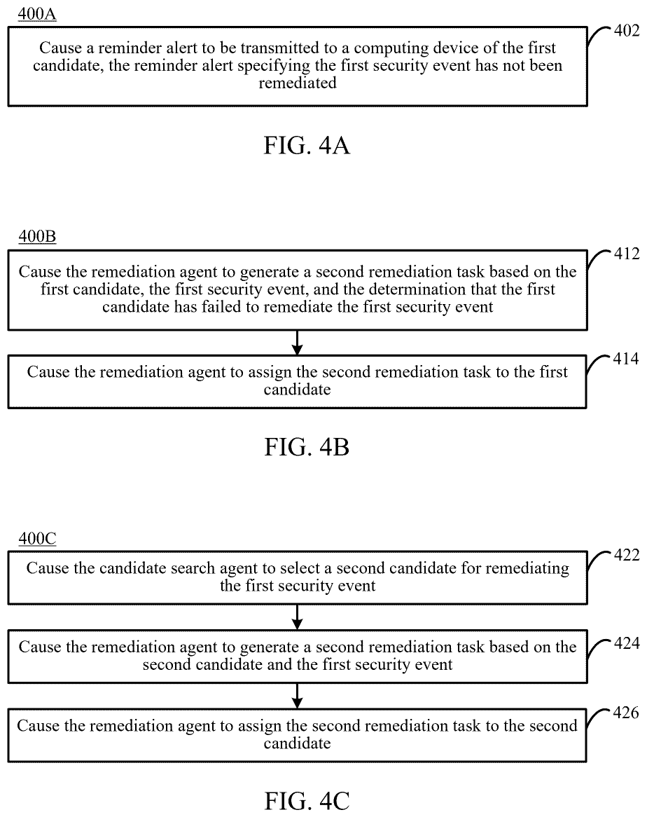

As described herein, monitoring agent 122 can cause a mitigation step to be performed if a remediation task or candidate is unsuccessful in remediating a security event. Example mitigation steps include, but are not limited to, causing a reminder alert to be transmitted to a candidate computing device associated with the selected candidate, causing a new remediation task to be generated and assigned to the selected candidate, causing a new candidate to be selected for remediating the security event and a new remediation task to be generated and assigned to the new candidate, and/or performing other operations to mitigate failure to remediate a security event. Additional details regarding mitigation steps are described with respect to FIGS. 4A-4C, as well as elsewhere herein. In accordance with an embodiment, monitoring agent 122 utilizes mitigation model 132 of model server 108 to generate a mitigation step. Additional details regarding generating a mitigation step utilizing mitigation model 132 are described with respect to FIGS. 15 and 16, as well as elsewhere herein.

As stated above, model server 108 comprises candidate selection model 128, task generation model 130, and mitigation model 132. Candidate selection model 128, task generation model 130, and mitigation model 132 are trained machine learning (ML) models. In an example, candidate selection model 128, task generation model 130, and/or mitigation model 132 are generative AI models, such as LLMs. In an embodiment, candidate selection model 128 is trained on a corpus of information to select a candidate for remediation of a security event, task generation model 130 is trained on a corpus of information to generate a remediation task for remediating a security event, and mitigation model 132 is trained on a corpus of information to detect failure in remediating a security event and/or to generate a mitigation step. In some embodiments, candidate selection model 128, task generation model 130, and/or mitigation model 132 are implemented as a general generative AI model in combination with a specialized agent that causes the general generative AI model to generate results relevant to the agent's operations. In some embodiments, candidate selection model 128, task generation model 130, and/or mitigation model 132 utilize the same underlying general generative AI model.

Model training system 114 is configured to train candidate selection model 128, task generation model 130, and/or mitigation model 132. For instance, model training system 114 trains a model on a respective corpus of information to generate respective output. For instance, model training system 114 trains candidate selection model 128 on a corpus of training data comprising candidate data (e.g., candidate data 1) and security event data (e.g., from security event logs). In this context, the candidate data specifies a plurality of candidates and corresponding roles, privileges and/or organizational information and the security event data specifies at least one security event with respect to at least one computing resource and information related to the at least one security event. Model training system 114 utilizes the training data to train candidate selection model 128 to rank candidates based on a level of semantic similarity between respective candidate data and the security event data. In another aspect, model training system 114 trains task generation model 130 on a corpus of training data comprising task data, candidate data, and security event data to generate a remediation task for remediating the security event. In this context, task data specifies tasks for remediating security events. In another aspect, model training system 114 trains mitigation model on a corpus of training data comprising task assignment data specifying tasks assigned to candidates, logged data and mitigation data to identify a failure or success in remediating a security event and/or to generate a mitigation step for mitigating a detected failure. In this context, task assignment data specifies remediation tasks assigned to candidates, logged data specifies activity logs of the candidates, and mitigation data specifies examples of mitigation steps. In an embodiment, model training system 114 evaluates an accuracy of output generated by the trained model and adjusts weights of the model based on the evaluation. Model training system 114 can utilize a variety of supervised, semi-supervised, or unsupervised techniques for training a respective model.

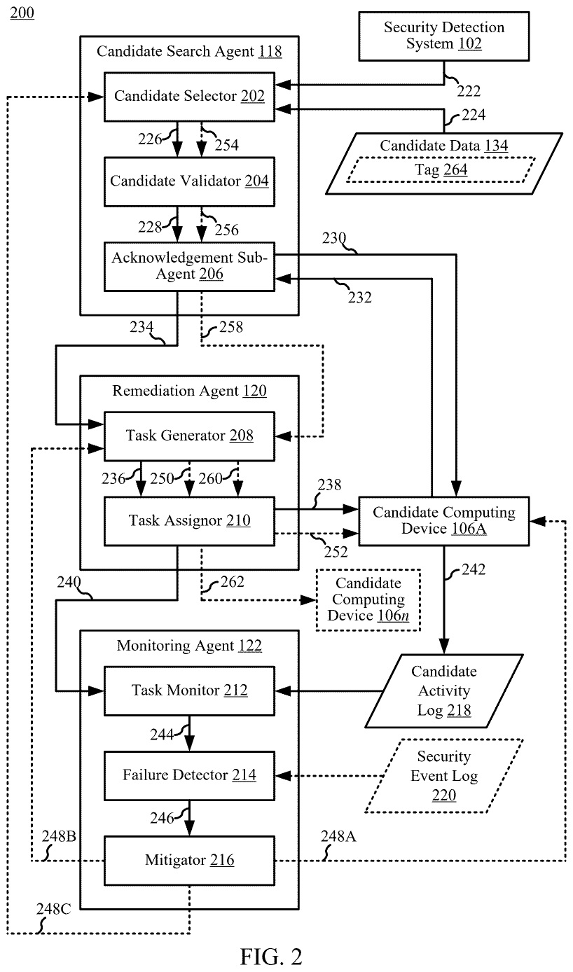

Embodiments of task assignment manager 116 can be configured in various ways for remediating and monitoring security events. For example, FIG. 2 shows a block diagram of a system 200 for mitigating security events, in accordance with another example embodiment. System 200 comprises security detection system 102, candidate computing device 106A, (optionally) candidate computing device 106n, candidate search agent 118, remediation agent 120, monitoring agent 122, and candidate data 134 as described with respect to FIG. 1, as well as a candidate activity log 218 and (optionally) a security event log 220. Candidate activity log 218 is an example log of candidate activity logs 136 and security event log 220 is an example log of security event logs 138, as respectively described with respect to FIG. 1. As also shown in FIG. 2, candidate search agent 118 comprises a candidate selector 202, a candidate validator 204, and an acknowledgement sub-agent 206, remediation agent 120 comprises a task generator 208 and a task assignor 210, and monitoring agent 122 comprises a task monitor 212, a failure detector 214, and a mitigator 216. Candidate selector 202, candidate validator 204, acknowledgement sub-agent 206, task generator 208, task assignor 210, task monitor 212, failure detector 214, and mitigator 216 are implemented as respective sub-services or sub-components of their respective agents.

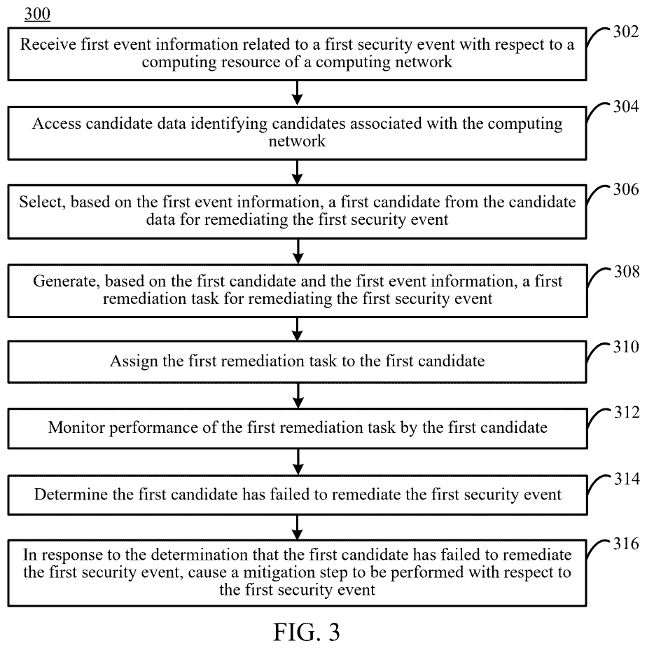

In order to better understand the operation of candidate search agent 118, remediation agent 120, and monitoring agent 122 of FIG. 2, FIG. 2 is described with respect to FIG. 3. FIG. 3 shows a flowchart of a process for mitigating security events, in accordance with an example embodiment. In an embodiment, candidate search agent 118, remediation agent 120, and monitoring agent 122 of FIG. 2 operate according to one or more steps of flowchart 300. Note not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, first event information related to a first security event with respect to a computing resource of a computing network is received. For example, candidate selector 202 of FIG. 2 receives event information 222 related to a first security event with respect to a computing resource of system 200. In an example, suppose the first security event is with respect to computing device 110 of FIG. 1. Event information 222 specifies information with respect to the detected security event, as described herein. In an embodiment, event information 222 is a snapshot of a security event log of the first security event generated by security detection system 102.

In step 304, candidate data identifying candidates associated with the computing network is accessed. For example, candidate selector 202 accesses at least a portion 224 of candidate data 134 identifying candidates associated with the computing network. In an embodiment, portion 224 describes information relating to one or more candidate profiles of candidate profiles 124A-124n.

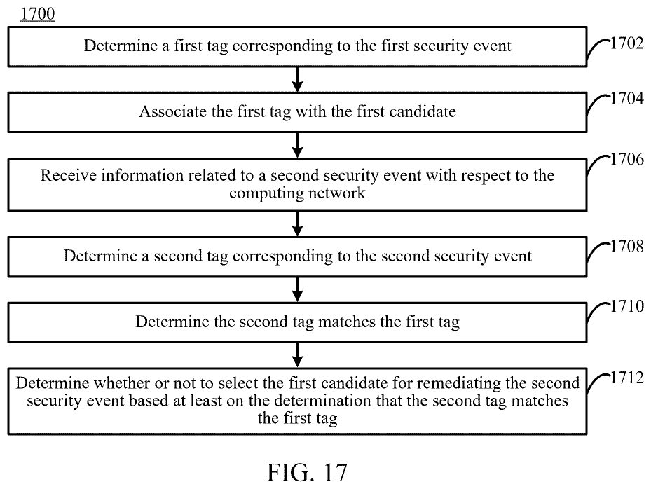

In step 306, a first candidate is selected, based on the first event information, from the candidate data for remediating the first security event. For example, candidate selector 202 selects a first candidate 226 (“candidate 226” herein) for remediating the first security event based on event information 222. In an embodiment, candidate selector 202 selects candidate 226 from among candidates based on a semantic similarity between candidate 226's profile (or portion thereof) and event information 222 satisfying a similarity threshold. For example, candidate selector 202 can select a candidate that maintains or has access to resources impacted by the security event because the candidate has a higher level of semantic similarity to the security event than a candidate that does not have access to the impacted resources. In another example, a candidate that has remediated similar security events can have a higher level of semantic similarity to the security event than a candidate that has not remediated similar security events. In an embodiment, candidate selector 202 selects candidate 226 based on a tag of candidate 226 matching a tag of event information 222. For instance, as shown in FIG. 2, candidate data 134 optionally comprises a tag 264. Additional details regarding tags are described with respect to FIG. 17, as well as elsewhere herein. In an embodiment, candidate selector 202 selects candidate 226 based on a relationship between candidate 226 and a user associated with the compute resource. For instance, suppose computing device 110 is associated with a user “User A”, an employee at an organization. Further suppose candidate selector 202 identifies a candidate “Candidate C” as a manager of User A in the organization. Candidate selector 202 can determine if the security event is likely to be remediated by the manager of User A and, if so, select Candidate C for remediating the security event.

In some embodiments, and as shown in FIG. 2, candidate validator 204 validates the selection of candidate 226. In the candidate validation step, candidate validator 204 determines whether or not candidate 226 is a valid selection for remediating the first security event. If not, candidate validator 204 causes candidate selector 202 to select a new candidate. If so, candidate validator 204 provides a validated selection 228 to acknowledgement sub-agent 206. Additional details regarding validation of a candidate are described with respect to FIG. 9, as well as elsewhere herein.

In some embodiments, and as shown in FIG. 2, acknowledgement sub-agent 206 causes a user to accept selection thereof for remediating a security event. For instance, suppose candidate computing device 106A corresponds to candidate 226. As shown in FIG. 2, acknowledgement sub-agent 206 transmits a selection approval request 230 to candidate computing device 106A. Candidate 226 can interact with candidate computing device 106A to generate a response 232. Alternatively, an automated system of candidate computing device 106A automatically generates response 232. Response 232 indicates whether or not candidate 226 or the automated system accepts selection for remediating the security event. If so, acknowledgement sub-agent 206 provides candidate selection information 234 to remediation agent 120. If not, acknowledgement sub-agent 206 causes candidate selector 202 to select a different candidate for remediating the security event.

In step 308, a first remediation task is generated based on the first candidate and the first event information, the first remediation task for remediating the first security event. For example, task generator 208 generates a first remediation task 236 (“remediation task 236” herein) based on candidate 226 and event information 222. Remediation task 236 comprises steps for remediating the first security event. Depending on the implementation, remediation task 236 comprises a recommendation for one or more steps to be performed and/or instructions that cause automatic performance of one or more steps. For instance, in an embodiment, remediation task comprises a recommendation to be presented in a user interface (UI) of candidate computing device 106A, the recommendation describing one or more steps to be performed to remediate the security event. In another example, the remediation task comprises instructions that cause an automated service or component of candidate computing device 106A to automatically perform a task or sub-step of a task to remediate a security event. In another example, the remediation task comprises instructions that cause an automated service or component of remediation agent 120 or a security system associated therewith to automatically perform a task or sub-step of a task to remediate a security event. In another example, a remediation task comprises at least a first sub-step to be assigned to candidate 226 and a second sub-step to be automatically performed by candidate computing device 106A, an automated service or component of remediation agent 120, or an associated security system. Example sub-steps to be automatically performed include, but are not limited to, increasing restrictions of a firewall, enabling a firewall, resetting credentials of a user account, isolating a compromised resource, isolating sensitive resources or other data from a compromised account, disabling a resource, temporarily disabling a resource, enabling a multi-factor authentication policy for accessing a resource or sensitive data threatened by the security event, restricting network access to remote resources, and/or other tasks or sub-tasks remediation agent 120 or another component/service can perform in conjunction with, prior to, in parallel to, or otherwise in addition to the sub-task or sub-tasks assigned to candidate 226. In an embodiment, potential sub-steps to be automatically performed are defined by a security system policy. In some embodiments, certain sub-steps can be authorized with respect to a subset of resources of the computing network system or all resources of the computing network system. For example, a security system policy can define which resources can be automatically disabled. For instance, resources that are infrequently accessed (e.g., a number of accesses in a predetermined time period is below a threshold, a time since last accessed is above a threshold, etc.) can be automatically disabled but resources that are frequently accessed (e.g., a number of accesses in a day or other predetermined time period is above a threshold and/or the like) or that would have a relatively large negative impact on operations of the organization or its computing network system if disabled cannot be automatically disabled without candidate intervention. In embodiments, task generator 208 can generate natural language or code to generate remediation task 236.

In step 310, the first remediation task is assigned to the first candidate. For example, task assignor 210 assigns remediation task 236 to candidate 226 by transmitting a task assignment signal 238 to candidate computing device 106A corresponding to candidate 226. As also shown in FIG. 2, task assignor 210 transmits an assignment signal 240 to monitoring agent 122 notifying monitoring agent 122 of a new task assigned to a candidate. In an alternative embodiment, task assignor 210 updates a table or ledger of in-progress remediation tasks with information associating remediation task 236 to the first security event and candidate 226. In this context, monitoring agent 122 or other services or devices can access the table or ledger for task status and assignment information. In an aspect where remediation task 236 comprises at least a first sub-task to be assigned to candidate 226 and a second sub-task to be automatically performed by a component or service, task assignor 210 assigns the first sub-task to candidate 226 via task assignment signal 238 and causes the second sub-task to be automatically performed. For instance, suppose remediation task 236 comprises a first sub-task to address irregular activity of a user account and a second sub-task to automatically reset credentials of the user account. In this example, task assignor 210 assigns the first sub-task to candidate 226 and automatically causes credentials of the user account to be disabled.

In step 312, performance of the first remediation task by the first candidate is monitored. For example, task monitor 212 monitors performance of remediation task 236 by accessing candidate activity log 218. In this example, candidate activity log 218 comprises records of a candidate profile of candidate 226. As shown in FIG. 2, as candidate computing device 106A performs operations, records 242 are added to candidate activity log 218. In this manner, task monitor 212 can monitor whether or not candidate 226 has performed operations in accordance with remediation task 238. If candidate computing device 106A is utilized to perform a step of remediation task 236, record 242 comprising a recordation of the step is included in candidate activity log 218. Depending on the implementation, task monitor 212 periodically checks candidate activity log 218 for updates, receives update information regarding candidate activity log 218 subsequent to it being updated, or accesses candidate activity log 218 subsequent to a triggering event. For instance, in an embodiment, task monitor 212 accesses candidate activity log 218 subsequent to a measure of time since remediation task 236 was assigned to candidate 226 meeting or exceeding a threshold. As shown in FIG. 2, task monitor 212 provides accessed information 244 to failure detector 214.

In step 314, the first candidate is determined to have failed to remediate the first security event. For example, failure detector 214 of FIG. 2 determines whether or not candidate 226 has failed to remediate the first security event. Failure detector 214 determines the failure based on whether or not candidate 226 has completed or begin remediation task 236 within a predetermined time, based on whether or not candidate 226 performed the remediation task 236 correctly, based on whether or not remediation task 236 successfully remediated the first security event, and/or based on other criteria for determining whether or not a remediation task has successfully remediated a security event. If the security event is remediated, failure detector 214 causes monitoring agent 122 to clear the security event and cease monitoring for tasks performed with respect to the event. If the security event is not remediated, failure to remediate the event is detected and a failure detection signal 246 is provided to mitigator 216.

In step 316, in response to the determination that the first candidate has failed to remediate the first security event, a mitigation step is caused to be performed with respect to the first security event. For example, mitigator 216 causes a mitigation step to be performed with respect to the security event in response to the determination that candidate 236 has failed to remediate the security event. Depending on the implementation, mitigator 216 causes various mitigation steps to be performed to mitigate failure to remediate a security event. In some embodiments, mitigator 216 causes multiple steps to be performed. Additional examples of mitigation steps are described with respect to FIGS. 4A-4C, as well as elsewhere herein.

As described with respect to FIG. 3, in response to determining a candidate has failed to remediate a security event, monitoring agent 122 can cause a mitigation step to be performed. Mitigation steps can comprise various steps or substeps, in embodiments. For instance, in an embodiment, a mitigation step comprises a reminder alert to a candidate. Mitigator 216 of FIG. 2 can cause a reminder alert to be transmitted to a candidate in various ways, in embodiments. For instance, FIG. 4A shows a flowchart 400A of a process for performing a mitigating step, in accordance with an example embodiment. In an embodiment, mitigator 216 of FIG. 2 operates according to one or more steps of flowchart 400A. Note not all steps of flowchart 400A need be performed in all embodiments. Further structural and operational embodiments will be apparent to persons skilled in the relevant art(s) based on the following descriptions of FIG. 4A with respect to FIG. 2.

Flowchart 400A comprises step 402. In step 402, a reminder alert is caused to be transmitted to a computing device of the first candidate, the reminder alert specifying the first security event has not been remediated. For example, as shown in FIG. 2, mitigator 216 can transmit a reminder alert 248A to candidate computing device 106A specifying the first security event has not been remediated. In an embodiment, reminder 248A indicates whether or not candidate 226 has performed remediation task 238 or if there was an error in a recorded attempt to perform a remediation task. In accordance with an embodiment, mitigator 216 utilizes a generative AI model to generate a natural language reminder based on the detected failure indicated in failure detection signal 246, event information 222, and candidate 226.

As stated herein, mitigation steps can comprise various steps or substeps. For instance, a mitigation step can comprise generating new remediation tasks. Mitigator 216 of FIG. 2 can cause new remediation tasks to be generated in various ways. For example, FIG. 4B shows a flowchart 400B of a process for performing a mitigating step, in accordance with another example embodiment. In an embodiment, mitigator 216 of FIG. 2 operates according to one or more steps of flowchart 400B. Note not all steps of flowchart 400B need be performed in all embodiments. Further structural and operational embodiments will be apparent to persons skilled in the relevant art(s) based on the following descriptions of FIG. 4B with respect to FIG. 2.

Flowchart 400B begins with step 412. In step 412, the remediation agent is caused to generate a second remediation task based on the first candidate, the first security event, and the determination that the first candidate has failed to remediate the first security event. For example, mitigator 216 of FIG. 2 transmits instructions 248B to remediation agent 120, causing remediation agent to generate a second remediation task 250 based on candidate 226, the first security event, and the determination that candidate 226 has failed to remediate the first security event via remediation task 236. In an embodiment, mitigator 216 generates instructions 248B subsequent to candidate 226 performed remediation task 236 but the task failed in remediating the security event. In an alternative embodiment, mitigator 216 receives a response to reminder 248A from candidate computing device 106A indicating candidate 226 is requesting an alternative remediation task or is unable to perform remediation task 236.

In step 414, the remediation agent is caused to assign the second remediation task to the first candidate. For instance, subsequent to receiving instructions 248B and generating remediation task 250, task assignor 210 is caused to assign remediation task 250 via a task assignment signal 252. Task assignor 210 assigns task 250 in a similar manner as task 236 was assigned in step 310 of flowchart 300 of FIG. 3.

As stated herein, mitigation steps can comprise various steps or substeps. For instance, a mitigation step can comprise searching for a new candidate and generating a new task. Mitigator 216 of FIG. 2 can cause new candidates to be selected and tasks to be generated in various ways. For example, FIG. 4C shows a flowchart 400C of a process for performing a mitigating step, in accordance with another example embodiment. In an embodiment, mitigator 216 of FIG. 2 operates according to one or more steps of flowchart 400C. Note not all steps of flowchart 400C need be performed in all embodiments. Further structural and operational embodiments will be apparent to persons skilled in the relevant art(s) based on the following descriptions of FIG. 4C with respect to FIG. 2.

Flowchart 400C begins with step 422. In step 422, the candidate search agent is caused to select a second candidate for remediating the first security event. For example, suppose mitigator 216 determines candidate 226 is unable to remediate the security event based at least on the detected failure to perform task 236. In this context, mitigator 216 transmits instructions 248C to candidate search agent 118. Instructions 248C cause candidate search agent 118 to select a second candidate 254 (“candidate 254” herein) for remediating the first security event. Candidate search agent 118 selects candidate 254 in a similar manner as selection of candidate 226. In an embodiment, candidate 254 is a second most-likely candidate to remediate security event (e.g., wherein candidate 226 was the first). In another example, candidate 254 is a previously unavailable candidate with a higher likelihood of remediating the security event than candidate 226. In an example, candidate validator 204 validates candidate 254 in a similar manner as candidate 226, resulting in a validated selection 256 if candidate 254 is valid. In a further embodiment, acknowledgement sub-agent 206 transmits acknowledgement request to candidate computing device 106n corresponding to candidate 254.

In an embodiment, mitigator 216 generates instructions 248C subsequent to a new candidate triggering event. Example new candidate triggering events include, but are not limited to, a number of reminders transmitted to candidate 226 exceeding a threshold, a time since remediation task 236 was assigned to candidate 226 exceeding a threshold, a number of attempts to remediate the security event by candidate 226 exceeding a predetermined number, candidate 226 transmitting a request for reassignment of remediation of the security event, a manager of candidate 226 transmitting a request for reassignment of remediation of the security event, and/or another event that when triggered, causes mitigator 216 to generate instructions for a new candidate.

In step 424, the remediation agent is caused to generate a second remediation task based on the second candidate and the first security event. For example, task generator 208 receives selection information 258 from candidate search agent 118 and generates a second remediation task 260 (“remediation task 260” herein) based on candidate 254 and event information 222. In an embodiment, task generator 208 generates remediation task 260 in a similar manner as described with respect to remediation task 236.

In step 426, the remediation agent is caused to assign the second remediation task to the second candidate. For example, task assignor 210 is caused to assign remediation task 260 to candidate computing device 106n via a task assignment signal 262, e.g., in a similar manner as described with respect to task assignment signals 238 and/or 252.

Thus, examples of systems, task assignment managers, and agents have been described with respect to remediating security events. In order to better understand the operation of candidate search agents, remediation agents, and monitoring agents, further examples of agents, subcomponents of agents, associated components, and their operations are described herein.

### A. Candidate Search and Validation Embodiments

As described herein, candidate search agent 118 is configured to select a candidate for remediating a security event. Candidate search agent 118 can be implemented in various ways, in embodiments. For example, FIG. 5 shows a block diagram of a system 500 comprising the candidate search agent of FIG. 1. As shown in FIG. 5, system 500 comprises candidate computing device 106A, candidate search agent 118 (comprising candidate selector 202, candidate validator 204, and acknowledgement sub-agent 206 of FIG. 2), and candidate selection model 128 as described with respect to FIG. 1, as well as candidate data 512. Candidate data 512 is an example of candidate data 134 and, as shown in FIG. 5, specifies a second security event 530 previously remediated by a candidate. As also shown in FIG. 5, candidate selection model 128 comprises a candidate search sub-model 502 and an embeddings sub-model 504, each of which are implemented as sub-models of candidate selection model 128 or separate ML models. Candidate search sub-model 502 is trained to search for candidates for remediating a task based on a security event and embeddings sub-model 504 is trained to generate vector embeddings that semantically represent input data. In an embodiment, embeddings sub-model 1028 is generated on a large corpus of information, e.g., information gathered from crawling the Internet and/or other records. In embodiments, candidate search sub-model 502 and embeddings sub-model 504 are implemented in a single model or as separate models.

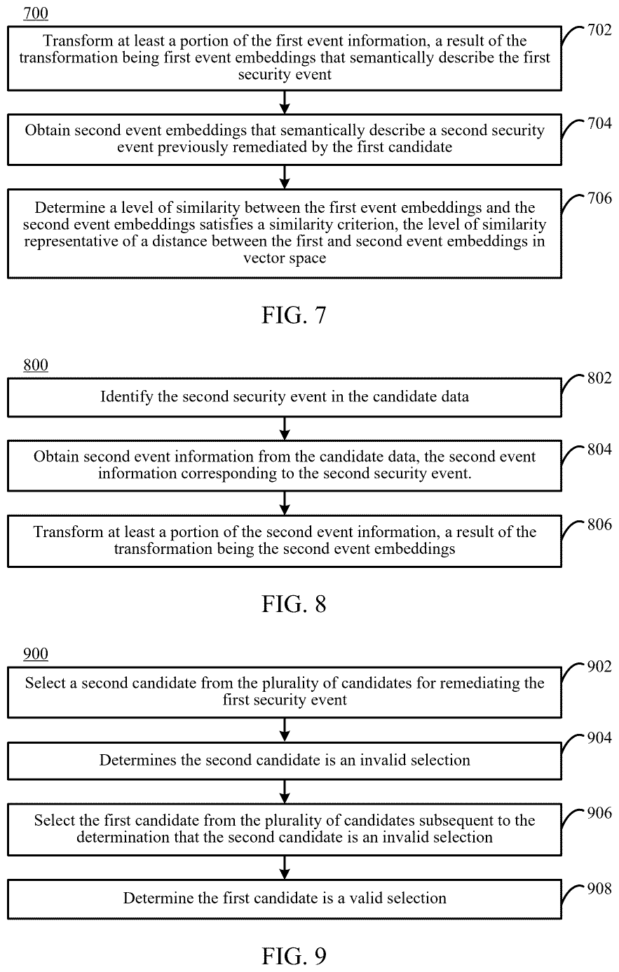

As described herein, embeddings sub-model 504 generates embeddings based on input. The embeddings are usable for machine learning. Embeddings are information dense representations of semantic meaning of an input (e.g., a piece of text). For example, in accordance with an embodiment, an embedding is a vector of floating-point numbers such that the distance between two embeddings in vector space is correlated with the semantic similarity between two inputs in their original format (e.g., text format). As an example, if two texts are similar, their vector representations should also be similar. In an embodiment, vectors are considered semantically similar if their values match above a certain percentage (e.g., above 50%, above 90%, and/or the like). In another embodiment, vectors are considered semantically similar if the distance between them is within a predetermined threshold distance. In another example, two vectors within a group of multiple (e.g., three or more) vectors are considered semantically similar if they are closer to each other in vector space than any other vector in the group, a majority of other vectors in the group, or at least one other vector in the group. In these manners, embeddings generated by embeddings sub-model 504 provide representation of data usable by systems described herein for performing various functions associated with data represented by embeddings. For instance, candidate search agent 118 (or a component thereof) utilizes embeddings to select a candidate for remediating a security event (e.g., as described with respect to FIGS. 7 and 8, as well as elsewhere herein). Other embodiments described herein can utilize embeddings models that operate similar to embeddings sub-model 504 for performing other operations, such as remediation task generation or mitigation step generation.

To better understand the operation of candidate search agent 118 with respect to FIG. 5, FIG. 5 is described with respect to FIG. 6. FIG. 6 shows a flowchart 600 of a process for automatically selecting a candidate for remediating a security event, in accordance with an example embodiment. In an embodiment, candidate search agent 118 operates according to one or more steps of flowchart 600. Note not all steps of flowchart 600 need be performed in all embodiments. Further structural and operational embodiments will be apparent to persons skilled in the relevant art(s) based on the following descriptions of FIGS. 5 and 6.

Flowchart 600 begins with step 602. In step 602, a prompt comprising information related to the first security event and specifying the candidate data is generated, the prompt comprising instructions to access the candidate data and select a candidate for remediating the first security event. For example, candidate selector 202 generates a prompt 516 comprising information related to the security event and specifying candidate data accessed in step 304. In an embodiment, candidate selector 202 generates prompt 516 from event information 222. Prompt 516 comprises instructions to access candidate data 512.

In step 604, the prompt is provided to the generative AI model. For example, candidate selector 202 provides prompt 516 to candidate selection model 128, causing candidate selection model 128 to select candidate 226 for remediating a security event. In an embodiment, prompt 516 causes candidate selection model 128 to determine a plurality of potential candidates for remediating a security event. Prompt 516 causes candidate selection model 128 to rank the potential candidates based on a likelihood the candidate is a good fit for remediating the security event. Additional details regarding selection of candidates are described with respect to FIGS. 7 and 8, as well as elsewhere herein.

In step 606, a selection of the first candidate is received from the generative AI model. For example, candidate selector 202 receives a response 518 from candidate selection model 128. Response 518 comprises a selection of candidate 226 for remediating the security event. In embodiments where candidate selection model 128 selects multiple candidates, response 518 comprises a list of the candidates. In an embodiment, candidates of the list are ranked based on a likelihood of successfully remediating the security event.

Candidate search model 128 is configured to facilitate selection of a candidate for remediating a security event in various ways. For instance, FIG. 7 shows a flowchart 700 of a process for automatically selecting a candidate for remediating a security event, in accordance with an example embodiment. In an embodiment, candidate search model 128 of FIG. 5 operates according to one or more steps of flowchart 700. Note not all steps of flowchart 700 need be performed in all embodiments. Further structural and operational embodiments will be apparent to persons skilled in the relevant art(s) based on the following description of FIG. 7 with respect to FIG. 5.

Flowchart 700 begins with step 702. In step 702, at least a portion of the first event information is transformed into first event embeddings that semantically describe the first security event. For example, embeddings sub-model 504 of candidate selection model 128 transforms at least a portion of event information 222 into event embeddings 508. Event embeddings 508 semantically describe the first security event.

In step 704, second event embeddings that semantically describe a second security event previously remediated by the first candidate are obtained. For example, candidate search sub-model 502 obtains event embeddings 510 that semantically describe a second security event 530. Event embeddings 510 can be obtained from a data store or can be generated utilizing embeddings sub-model 504, e.g., as further described with respect to FIG. 8.

In step 706, a level of similarity between the first event embeddings and the second event embeddings is determined to satisfy a similarity criterion, the level of similarity representative of a distance between the first and second event embeddings in vector space. For example, candidate search sub-model 502 determines a level of similarity between event embeddings 508 and event embeddings 510 satisfy a similarity criterion. The level of similarity between embeddings 508 and 510 represents a distance between the embeddings in vector space. In some embodiments, candidate search sub-model 502 determines levels of similarity between event embeddings 508 and respective event embeddings of security events previously remediated by multiple candidates. In this context, candidate search sub-model 502 can rank the candidates based on their level of similarity to event embeddings 508. In an embodiment, candidate 226 is selected from among the plurality of candidates based on its ranking. Similarity of a candidate to a security event can be based on a variety of information including, but not limited to, a previous security event a candidate has remediated that is semantically similar to the present security event, a tool suitable for remediating the security event that the candidate has access to or has a degree of proficiency in, the candidate maintaining or having access to resources impacted by the security event, the candidate having administrative privileges with respect to impacted resources, the candidate being assigned to a security system or component (such as a firewall) that is affected by the security event, and/or the like. For instance, a candidate that maintains or has administrative access to resources impacted by the security event can have a higher level of semantic similarity to the security event (and therefore a higher rank) than a candidate that does not have administrative access to the impacted resources. In another example, a candidate that has previously remediated a security event semantically similar to the present security event can have a higher rank than another candidate that has not previously remediated a security event semantically similar to the present security event.

Candidate search model 128 is configured to obtain event embeddings 510 in various ways. For instance, in an embodiment, candidate search sub-model 502 accesses previously generated event embeddings to obtain event embeddings 510. In a further aspect, the previously generated event embeddings are included in candidate data 512. Alternatively, embeddings sub-model 504 generates event embeddings 510. For instance, FIG. 8 shows flowchart 800 of a process for obtaining event embeddings of a previously remediated security event, in accordance with an example embodiment. In an embodiment, candidate search model 128 of FIG. 5 operates according to one or more steps of flowchart 800. Note not all steps of flowchart 800 need be performed in all embodiments. Further structural and operational embodiments will be apparent to persons skilled in the relevant art(s) based on the following descriptions of FIG. 8 with respect to FIG. 5.

Flowchart 800 begins with step 802. In step 802, the second security event is identified in the candidate data. For example, candidate search sub-model 502 identifies second security event 530 in candidate data 512. In an aspect, candidate search sub-model 502 by evaluating previously performed remediation tasks performed by a first set of potential candidates. Alternatively, candidate search sub-model 502 identifies second security events based on tags of the security events matching tags of event information 222. Additional details regarding tags are described with respect to FIG. 17, as well as elsewhere herein. In another alternative, an indication of second security event 530 is included in prompt 516.

In step 804, second event information is obtained from the candidate data, the second event information corresponding to the second security event. For example, candidate search sub-model 502 obtains information describing security event 530 from candidate data 512. In an embodiment, candidate search sub-model 502 queries a data store storing candidate data 512. In another embodiment, candidate search sub-model 502 accesses security event logs to obtain the information.

In step 806, at least a portion of the second event information is transformed into the second event embeddings. For example, embeddings sub-model 504 transforms at least a portion of information describing second security event 530 into event embeddings 510. In an embodiment, candidate search sub-model 502 automatically generates a prompt or other type of input for embeddings sub-model 504 comprising information describing second security event 530. Candidate search sub-model 502 provides the prompt or other type of input to embeddings sub-model 504, causing embeddings sub-model 504 to generate event embeddings 510 semantically describing security event 530.

As described herein, candidate search agent 118 operates to validate a selected candidate. Candidate search agent 118 operates to validate candidates in various ways, in embodiments. For example, FIG. 9 shows a flowchart 900 of a process for candidate selection and validation, in accordance with an example embodiment. In an embodiment, candidate search agent 118 of FIG. 5 operates according to one or more steps of flowchart 900. Note not all steps of flowchart 900 need be performed in all embodiments. Further structural and operational embodiments will be apparent to persons skilled in the relevant art(s) based on the following descriptions of FIG. 9 with respect to FIG. 5.

Flowchart 900 begins with step 902. In step 902, a second candidate is selected from the plurality of candidates for remediating the first security event. For example, suppose candidate selector 202 selects a candidate other than candidate 226 from the plurality of candidates. In this context, the other candidate can be a candidate with a higher likelihood of remediating the security event or assigned a higher rank than candidate 226 by candidate selection model 128.

In step 904, the second candidate is determined to be an invalid selection. For example, candidate validator 204 determines whether or not the second candidate selected in step 902 is a valid selection. If the second candidate is a valid selection, the process continues to acknowledgment sub-agent 206 and to remediation task generation, as described elsewhere herein. If the second candidate is determined to be invalid, flowchart 900 continues to step 906. In embodiments, candidate validator 204 determines the second candidate is invalid in various ways. For instance, candidate validator 204 comprises logic for validating output of candidate selection model 128, such as verify the selected candidate is a candidate from the plurality of candidates. In another aspect, candidate validator 204 determines whether or not a backlog or list of workloads assigned to the candidate exceeds a threshold or meets a workload limit. If so, candidate validator 204 deprioritizes or otherwise invalidates the second candidate as a selection for remediating security events.

In step 906, the first candidate is selected from the plurality of candidates subsequent to the determination that the second candidate is an invalid selection. For example, responsive to or otherwise subsequent to determining the second candidate is determined to be an invalid selection, candidate validator 204 causes candidate selector 202 to select a new candidate from the plurality of candidates, e.g., as described with respect to step 306 of flowchart 300 of FIG. 3. In an embodiment, candidate selector 202 and candidate validator 204 repeat this selection and validation process until a valid candidate is selected.

In step 908, the first candidate is determined to be a valid selection. For example, candidate validator 204 validates candidate 226 as a valid selection for remediating the first security event. In this context, candidate validator 204 provides valid selection 228 indicating candidate 226 is a valid selection to acknowledgement sub-agent 206.

In some embodiments, candidate validator 204 can determine a candidate is a valid selection, but other components and/or services determine the candidate is invalid. For instance, acknowledgement sub-agent 206 can determine whether or not the candidate or the candidate's system (e.g., candidate computing device 106A) is able to accept assignment of remediating the first security event. For example, as shown in FIG. 5, acknowledgement sub-agent 206 transmits selection approval request 230 to candidate computing device 106A. Selection approval request 230 specifies the candidate or their system has been selected for remediating a security task. In an aspect, selection approval request 230 also includes an indication that a recommended remediation task or instructions for performing a remediation task are to be transmitted subsequent to the candidate or their system accepting the assignment of remediating the security event. In an implementation, acknowledgement sub-agent 206 causes the request to be presented in a UI of candidate computing device 106A. As further shown in FIG. 5, acknowledgement sub-agent 206 receives a response 232 from candidate computing device 106A. Response 232 indicates whether or not the candidate or their system has accepted assignment of remediating the security event. In an embodiment, response 232 is generated subsequent to user interaction with a UI of candidate computing device 106A (e.g., to select an option accepting or denying the assignment). Alternatively, response 232 is automatically generated by candidate computing device 106A (e.g., automatically accepting if a user setting authorizes acceptance of new tasks that satisfy certain criteria, automatically denying if a workload backlog exceeds a threshold, automatically denying if the candidate is unavailable in a specified time frame, and/or the like). In embodiments, if response 232 indicates the assignment has been accepted, acknowledgement sub-agent 206 provides candidate selection information 234 to remediation agent 120, e.g., as described with respect to FIGS. 2 and 3. If the assignment has been denied or otherwise rejected, acknowledgement sub-agent 206 causes candidate selector 202 to select a different candidate for remediating the security event.

### B. Remediation Task Generation and Assignment Embodiments

As described herein, remediation agent 120 is configured to generate and assign remediation tasks. Systems including remediation agent 120 can be configured in various ways. For example, FIG. 10 shows a block diagram of a system 1000 comprising the remediation agent of FIG. 1. As shown in FIG. 10, system 1000 comprises candidate computing device 106A, remediation agent 120 (comprising task generator 208 and task assignor 210), task generation model 130, security event log 220, and candidate data 512 (comprising second security event 530) as described with respect to FIGS. 1, 2, and 5. As also shown in FIG. 10, remediation agent further comprises a user interface (UI) manager 1002, candidate computing device 106A comprises a UI 1004, task generation model 130 comprises a potential task generation sub-model 1006, a task evaluation sub-model 1008, and an embeddings sub-model 1028, and candidate data 512 further comprises candidate privilege data 1010. UI manager 1002 is a sub-service of remediation agent 120 is configured to cause information to be presented in UI 1004 and receive input from UI 1004. UI 1004 is an interface that enables user interaction with candidate computing device 106A. In an example, UI 1004 is a further example of application 126 of FIG. 1. Potential task generation sub-model 1006 is trained on a corpus of information to generate remediation tasks for remediating security events. Task evaluation sub-model 1008 is trained on a corpus of information to rank remediation tasks based on a likelihood of successfully remediating a security event. Embeddings sub-model 1028 is trained to generate vector embeddings that semantically represent input data. In an embodiment, embeddings sub-model 1028 is generated on a large corpus of information, e.g., information gathered from crawling the Internet and/or other records. In embodiments, potential task generation sub-model 1006, task evaluation sub-model 1008, and/or embeddings sub-model 1028 are implemented in separate models or combined models. Candidate privileged data 1010 specifies privileges (e.g., levels of access) a candidate has to resources of a computing system.

Embeddings sub-model 1028 operates in a similar manner as embeddings sub-model 504 described with respect to FIG. 5. Embeddings sub-model 1028 generates embeddings based on input. The embeddings are usable for machine learning and are information dense representations of semantic meaning of an input. As described elsewhere herein, if two inputs are similar, their embeddings are also similar. Examples on how embeddings/vectors are considered semantically similar are described with respect to embeddings sub-model 504 of FIG. 5, as well as elsewhere herein. In these manners, embeddings generated by embeddings sub-model 1028 provide representation of data usable by systems described herein for performing various functions associated with data represented by embeddings. For instance, remediation agent 120 (or a component thereof) or another sub-model of task generation model 130 utilizes embeddings generated by embeddings sub-model 1028 in generation of, evaluation of, and/or selection of remediation tasks for remediating a security event.

To better understand the operation of remediation agent 120 with respect to FIG. 10, FIG. 10 is described with respect to FIG. 11. FIG. 11 shows a flowchart 1100 of a process for generating a remediation task, in accordance with an example embodiment. In an embodiment, remediation agent 120 of FIG. 10 operates according to one or more steps of flowchart 1100. Note not all steps of flowchart 1100 need be performed in all embodiments. Further structural and operational embodiments will be apparent to persons skilled in the relevant art(s) based on the following descriptions of FIGS. 10 and 11.

Flowchart 1100 begins with step 1102. In step 1102, a prompt comprising information related to the first security event is generated, the prompt comprising instructions to generate a task to remediate the first security event. For example, task generator 208 generates a prompt 1014 comprising information related to the first security event. In examples, the prompt comprises instructions to generate a task to remediate the first security event. The prompt can specify information related to the first security event, the candidate selected to perform the task (e.g., candidate 226 of FIG. 2), a level of risk the security event poses to a system, previous tasks utilized to remediate semantically similar security events, candidate data of the selected candidate, and/or other information related to the security event or selected candidate. For instance, in an example, task generator 208 utilizes embeddings sub-model 1028 to generate event embeddings 1030 that semantically represent the first security event and generate or otherwise access event embeddings 1032 that semantically represent previously remediated security events. Task generator 208 determines, based on a distance between embeddings 1030 and 1032 in vector space, a level of similarity between the first security event and at least one previously remediated security event satisfies a threshold. In this example, task generator 208 includes the previously remediated security event and a remediation task performed to remediate the previously remediated security event as an example remediation in prompt 1014.

In step 1104, the prompt is provided to the generative AI model. For example, as shown in FIG. 10, task generator 208 provides prompt 1014 to task generation model 130. Prompt 1014 causes task generation model 130 to generate a remediation task for remediating the security event. For instance, in an example, potential task generation sub-model 1006 generates one or more tasks for remediating the security event and task evaluation sub-model 1008 evaluates the remediation tasks based on a measure of their likelihood of successfully remediating the security event. In an embodiment, the prompt specifies limitations the remediation task is to satisfy. For instance, a prompt can specify a number of steps the task is limited to, an expected time frame the task is to be performed within, a limit on the amount of compute resources to be expended or otherwise utilized in performing the task, a limit on the number of actors in performing the task (e.g., the number of users needed to perform the task, the number of application or services to perform the task, and/or the like), and/or other limitations that can be placed on a task for remediating a security event. In accordance with an embodiment, task generator 208 can include information that overlaps between candidate 226 and the first security event. For instance, task generator 208 can include in the prompt an indication of tags that matched between candidate 226 and the first security event. In another example, task generator 208 specifies in the prompt a semantically similar previously remediated security event. In an embodiment, prompt 1014 comprises locations of data task generation model 130 is to utilize to generate remediation task 236. For instance, prompt 1014 comprises a location of security event log 220 or candidate data 512.

In step 1106, the first remediation task is received from the generative AI model. For example, as shown in FIG. 10, task generator 208 receives response 1016 from task generation model 130. In an embodiment, response 1016 comprises remediation task 236. In another embodiment, response 1016 comprises a plurality of tasks including remediation task 236. In a further aspect, the plurality of tasks are ranked based on a likelihood the remediation task would lead to remediation of the security event. In an embodiment, the plurality of tasks are ranked based on a level of difficulty in completing the respective task. In an embodiment, a plurality of tasks are received and the order in which they are to be performed is specified in response 1016.

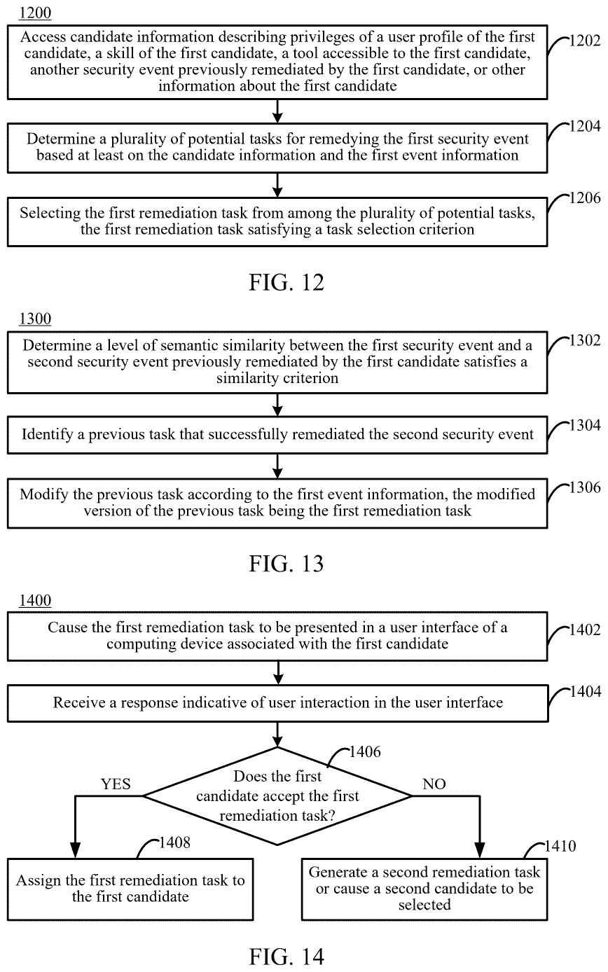

Task generation model 130 operates in various ways to generate a remediation task. For instance, task generation model 130 can operate to select a remediation tasks from a plurality of tasks. As an example, FIG. 12 shows a flowchart 1200 of a process for generating a remediation task, in accordance with another example embodiment. In an embodiment, task generation model 130 operates according to one or more steps of flowchart 1200. Note not all steps of flowchart 1200 need be performed in all embodiments. Further structural and operational embodiments will be apparent to persons skilled in the relevant art(s) based on the following description of FIG. 12 with respect to FIG. 10.

Flowchart 1200 begins with step 1202. In step 1202, candidate information is accessed, the candidate information describing privileges of a user profile of the first candidate, a skill attributed to the first candidate, a tool accessible to the first candidate, another security event previously remediated by the first candidate, or other information about the first candidate. For example, potential task generation sub-model 1006 accesses candidate data 512. In embodiments, candidate data 512, describes privileges of a candidate user profile (e.g., candidate privilege data 1010), a skill attributed to the candidate, a tool accessible to the candidate, a security event previously remedied by the candidate (e.g., security event 530), and/or other information associated with the first candidate.

In step 1204, a plurality of potential tasks for remedying the first security event is determined based at least on the candidate information and the first event information. For example, potential task generation sub-model 1006 generates a plurality of potential remediation tasks comprising remediation task 236 based at least on candidate data 512 and event information 222. Depending on the implementation, event information 222 is included in prompt 1014 or obtained by accessing security event log 220. Candidate data 512 can be included in prompt 1014 or obtained by accessing stored candidate data 512. Potential task generation sub-model 1006 can generate the plurality of potential tasks in a similar manner as described with respect to step 1104 of FIG. 11 or step 308 of FIG. 3.

In step 1206, the first remediation task is selected from among the plurality of potential tasks, the first remediation task satisfying a task selection criterion. For example, task evaluation sub-model 1008 selects remediation task 236 from among the plurality of tasks based at least on the task satisfying a task selection criterion and provides response 1016 comprising remediation task 236 (and optionally the other tasks). In another example, task generation model 130 provides response 1016 to task generator 208 comprising the plurality of remediation tasks and task generator 208 determines which remediation task satisfies the task selection criterion. Task evaluation sub-model 1008 or task generator 208 operate to determine which remediation task satisfies a task selection criterion in various ways. For example, in an embodiment, task evaluation sub-model 1008 measures a likelihood the remediation tasks are to successfully remediate the security event. Task evaluation sub-model 1008 can determine the likelihood based on a level of similarity between the remediation task and a previously performed remediation task performed to remediate a past security event (e.g., second security event 530) with a semantic similarity to the first security event that satisfies a similar event criterion. In an example, task evaluation sub-model 1008 utilizes embeddings sub-model 1028 to determine task embeddings 1034 representative of the generated remediation task and task embeddings 1036 representative of the previously performed remediation task. For instance, as a non-limiting example, suppose a previous remediation task comprising deploying a software patch to a resource impacted by a previous security event remediated the security event. In this example, further suppose the present security event exploiting a vulnerability in a different resource is semantically similar to the previous security event, e.g., based on a distance between event embeddings describing the events satisfying a similar event criterion. In this scenario, task evaluation sub-model 1008 generates a new remediation task to deploy the software patch (or a similar/modified patch) to the different resource. Task evaluation sub-model 1008 can evaluate the new remediation task by utilizing embeddings sub-model 1028 to generate task embeddings 1034 that semantically represent the new remediation task in vector space and utilizing embeddings sub-model 1028 to generate or accessing previously stored versions of text embeddings 1036 that semantically represent the previous remediation task in vector space. If the level of semantic similarity between task embeddings 1034 and 1036 satisfies a similar task criterion, task evaluation sub-model 1008 determines a likelihood of the new remediation task successfully remediating the present security event is above a threshold.

In another example, task evaluation sub-model 1008 selects remediation task 236 based on a likelihood candidate 226 is to perform the task in comparison to other remediation tasks. The likelihood candidate 226 is to perform the task is determined based on a semantic similarity between remediation task 236 and past tasks performed by candidate 226, a level of complexity of remediation task 236, an estimated time to perform remediation task 236, whether or not the remediation task requires an application or tool candidate 226 has not used in the past, and/or other factors that task evaluation sub-model 1008 can consider in determining a likelihood candidate 226 is to successfully perform the task. In a further embodiment, task evaluation sub-model 1008 selects a task based on multiple task selection criteria, e.g., selecting remediation task 236 based on a combination of a likelihood the remediation task is to remediate the security event and a likelihood candidate 226 is to successfully perform the remediation task. In an embodiment, the plurality of potential tasks are ranked based on at least one of the determined likelihoods and the highest ranked task is selected.

As described herein, task generation model 130 operates in various ways to generate a remediation task. For instance, task generation model 130 can generate a remediation task based on a previously performed remediation task. As an example, FIG. 13 shows a flowchart 1300 of a process for generating a remediation task, in accordance with another example embodiment. In an embodiment, task generation model 130 operates according to one or more steps of flowchart 1300. Note not all steps of flowchart 1300 need be performed in all embodiments. Further structural and operational embodiments will be apparent to persons skilled in the relevant art(s) based on the following descriptions of FIG. 13 with respect to FIG. 10.

Flowchart 1300 begins with step 1302. In step 1302, a level of semantic similarity between the first security event and a second security event previously remediated by the first candidate is determined to satisfy a similarity criterion. For example, potential task generation sub-model 1006 determines a level of semantic similarity between the first security event and second security event 530 satisfies a similarity criterion. In an embodiment, potential task generation sub-model 1006 determines the semantic similarity between the events by utilizing embeddings sub-model 1028 to generate event embeddings 1030 representative of the first security event and event embeddings 1032 representative of security event 530. In another aspect, potential task generation sub-model 1006 accesses previously generated versions of embeddings 1030 and/or 1032. For instance, in an aspect, event embeddings 1032 are stored in candidate data 512. In another aspect, embeddings 1030 and/or 1032 were generated in a manner as described with respect to flowcharts 700 and 800 of FIGS. 7 and 8 by an embeddings model utilized for searching for a candidate to remediate the first security event. For instance, in an embodiment, potential task generation sub-model 1006 accesses embeddings 508 and/or 510 that semantically represent the security event in vector space and were previously generated or accessed by candidate selection model 128 and/or a sub-model thereof. By utilizing previously generated embeddings, the number of compute resources expended in generating a task is reduced. In these examples, to determine the events are semantically similar, potential task generation sub-model 1006 determines a distance between event embeddings 1030 and 1032 in vector space satisfies a similarity criterion. While second security event 530 is a security event previously remediated by candidate 226, in some embodiments, potential task generation sub-model 1006 further considers other previously remediated security event that were remediated by other candidates, such as other candidates within the same team, department, or cohort as candidate 226, other candidates with the same role as candidate 226, or other candidates within the same organization as candidate 226.

In step 1304, a previous task that successfully remediated the second security event is identified. For example, potential task generation sub-model 1006 of FIG. 10 identifies a previous remediation task that successfully remediated security event 530. The task can be identified based on a security event log for security event 530 or candidate activity of the candidate that remediated security event 530.

In step 1306, the previous task is modified according to the first event information, the modified version of the previous task being the first remediation task. For example, potential task generation sub-model 1006 of FIG. 10 modifies the previous remediation task identified in step 1304 according to event information 222 (or other event information of the first security event, e.g., determined from security event log 220). For instance, in an embodiment where the previous remediation task references an impacted resource, potential task generation sub-model 1006 replaces the reference with a reference to resources impacted by the first security event. In an embodiment where the previous remediation task comprises a code snippet or patch, potential task generation sub-model 1006 modifies the code snippet or patch based on updates made to a system since the previous task was performed or changes or differences in variables between the security events. By modifying a previous task in this manner, potential task generation sub-model 1006 conserves compute resources in comparison to generating a new remediation task without using a previous task as a template. Furthermore, since the previous task was successful in remediating the previous security event, the likelihood the generated remediation task is in remediating the present security event is increased.

As stated above, potential task generation sub-model 1006 can generate multiple tasks. Furthermore, potential task generation sub-model 1006 can also consider previous remediation tasks performed by candidates other than the selected candidate in identifying previous tasks that successfully remediated semantically similar events. Suppose, in an example, potential task generation sub-model 1006 generates a first task by modifying a first past remediation task performed by candidate 226 in remediating a first semantically similar event, a second task by modifying a second past remediation task performed by a second candidate with the same role and in the same department as candidate 226 in remediating a second semantically similar event, and a third task by modifying a third past remediation task performed by a third candidate with the same role as and in a different department as candidate 226. In this example, task evaluation sub-model 1008 can weight ranks of the first, second, and third tasks based on a level of semantic similarity between respective candidate profiles of candidate 226 and candidate profiles of the other candidates. For instance, suppose the candidate profile of the second candidate has a higher level of semantic similarity to the candidate profile of candidate 226 than the candidate profile of the third candidate, e.g., the second candidate has the same role and works in the same department as candidate 226 whereas the third candidate has a different role and/or works in a different department than candidate 226. In this example, task evaluation sub-model 1008 applies a first (highest) weight to the first task since it is based on the task performed by candidate 226, a second (second highest) weight to the second task since it is based on the task performed by the second candidate, and a third (lowest/third highest) weight to the third task since it is based on the task performed by third candidate. By adjusting the weights of remediation tasks based on similarities in candidate profiles, task evaluation sub-model 1008 can increase the likelihood that candidate 226 is able to perform the remediation task successfully, as candidate 226 is more likely to have skills, privileges, and other capabilities as candidates with a higher level of semantic similarity to candidate 226.

In embodiments, remediation agent 120 assigns remediation tasks to candidates. Remediation agent 120 can operate in various ways to assign tasks. For instance, FIG. 14 shows a flowchart 1400 of a process for assigning a remediation task, in accordance with an example embodiment. In an embodiment, remediation agent 120 operates according to one or more steps of flowchart 1400. Note not all steps of flowchart 1400 need be performed in all embodiments. Further structural and operational embodiments will be apparent to persons skilled in the relevant art(s) based on the following description of FIG. 14 with respect to FIG. 10.

Flowchart 1400 begins with step 1402. In step 1402, the first remediation task is caused to be presented in a user interface of a computing device associated with the first candidate. For example, UI manager 1002 receives task assignment information 1020 from task assignor 210. Task assignment information 1020 indicates remediation task 236 and comprises any associated information (e.g., code or patch packages). Responsive to receiving task assignment information 1020, UI manager 1002 causes remediation task 236 to be presented in UI 1004 by transmitting a task assignment signal 1022 to candidate computing device 106A. Task assignment signal 1022 is an example of task assignment signal 238 as described with respect to FIG. 2. In an embodiment, task assignment signal 1022 comprises an assignment acceptance request that presents a selectable option in UI 1004.

In step 1404, a response indicative of user interaction in the user interface is received. For example, UI manager 1002 receives a response 1024 from candidate computing device 106A. Response 1024 in an embodiment comprises an indication of user interaction in UI 1004 to select a selectable option accepting, modifying, or denying the assignment. In an embodiment, response 1024 indicates the user requests an alternative remediation task. As shown in FIG. 10, UI manager 1002 provides response information 1026 indicative of response 1024.

In step 1406, a determination of whether or not the first candidate accepts the first remediation task is made. For example, task assignor 210 determines whether or not candidate 226 accepted assignment of remediation task 236 based at least on response information 1026. If the first candidate accepts the remediation task, flowchart 1400 continues to step 1408. Otherwise, flowchart 1400 continues to step 1410.

In step 1408, the first remediation task is assigned to the first candidate. For example, task assignor 210 of FIG. 10 marks remediation task 236 as assigned to candidate 226 and generates assignment signal 240, e.g., in a similar manner as described with respect to step 310 of FIG. 3.

In step 1410, a second remediation task is generated or a second candidate is selected for remediating the first security event. For example, suppose response 1024 indicates candidate 226 rejects assignment of remediation task 236. Depending on the implementation, task assignor 210 causes task generator 208 to generate a different remediation task to present in UI 1004, selects a different remediation task of a plurality of remediation tasks generated by task generator 208 to present in UI 1004, or causes candidate search agent 118 to select a different candidate for remediating the first security event.

### C. Monitoring and Mitigation Embodiments

Monitoring agent 122 is configured to monitor performance of remediation tasks and, if failure in performance is detected, mitigate the failure. Systems comprising monitoring agent 122 can be configured in various ways, in embodiments. For example, FIG. 15 shows a block diagram of a system 1500 comprising monitoring agent 122 of FIG. 1 (comprising task monitor 212, failure detector 214, and mitigator 216 of FIG. 2). As also shown in FIG. 15, system 1500 comprises mitigation model 130 as described with respect to FIG. 1 and security event log 220 and candidate activity log 218 as described with respect to FIG. 2. As further shown, mitigation model 130 comprises a status check sub-model 1502 and a mitigation step generation sub-model 1504, each of which are implemented as components of or sub-models of mitigation model 130. In an embodiment, status check sub-model 1502 is trained on a training corpus of information (comprising security event log data, candidate activity log data, timing data, and/or risk data) to detect failures and/or successes in remediating security events. In an embodiment, mitigation step generation sub-model 1504 is trained on a corpus of information (comprising candidate data, security event data, mitigation steps, and/or risk data) to generate mitigation steps for mitigating failure in remediating a security event.

To better understand the operation of monitoring agent 122 with respect to FIG. 15, FIG. 15 is described with respect to FIG. 16. FIG. 16 shows a flowchart 1600 of a process for detecting whether or not a security event has been mitigated and responding to the detection, in accordance with an example embodiment. In an embodiment, monitoring agent 122 of FIG. 15 operates according to one or more steps of flowchart 1600. Note not all steps of flowchart 1600 need be performed in all embodiments. Further structural and operational embodiments will be apparent to persons skilled in the relevant art(s) based on the following descriptions of FIGS. 15 and 16.

Flowchart 1600 begins with step 1602. In step 1602, a monitoring trigger criterion is determined to be satisfied. For example, task monitor 212 of FIG. 15 determines a monitoring trigger criterion is satisfied. Example monitoring criterion include, but are not limited to, an amount of time since remediation task 236 was assigned to candidate 226 reaching or exceeding a threshold period of time, a notification that candidate 226 completed remediation task 236, and/or other events or conditions that cause task monitor 212 to scan or otherwise determine if there was a failure in remediating a security event. Task monitor 212 can receive external input to determine if a monitoring triggering criterion is satisfied. For instance, in an embodiment, candidate computing device 106A transmits an indication (not shown in FIG. 15) to task monitor 212 subsequent to completion of remediation task 236. In another example, status check sub-model 1502 actively analyzes security event log 220 and/or candidate activity log 218 to identify indications of performance of remediation task 236 or remediation of the first security event.

In step 1604, a security log comprising a record of actions performed with respect to the first security event is accessed. For example, as shown in FIG. 15, status check sub-model 1502 accesses candidate activity log 218, where candidate activity log 218 comprises records of actions candidate 226 has performed. Alternatively or additionally, status check sub-model 1502 accesses security event log 220, where security event log 220 comprises records of actions performed with respect to the first security event. In an embodiment, status check sub-model 1502 actively accesses or scans the logs for changes or updates. Alternatively, and as shown in FIG. 15, status check sub-model 1502 receives a prompt 1508 from task monitor 212. In an embodiment, prompt 1508 comprises instructions to determine whether or not the first security event has been remediated by candidate 226. In an embodiment, status check sub-model 1502 generates a response 1510 to prompt 1508 indicating the status of the security event, any remediation tasks performed with respect to the event, and/or other activity of candidate 226. As shown in FIG. 15, task monitor 212 provides information included in response 1510 to failure detector 214 via accessed information 244.

In steps 1606 and 1608, a determination of whether or not the first candidate has remediated the first security event is made based on the security log. For example, failure detector 214 of FIG. 15 determines whether or not candidate 226 has remedied the first security event based on accessed information 244. In an example, failure detector 214 determines whether or not an identifier associated with the remediation task or security event is included in accessed information 244 to determine if the task has been performed. In another example where the remediation task included deploying a patch to a resource, status check sub-model 1502 accesses information of the resource to determine if the patch was successfully deployed and includes an indication of whether or not it has been deployed in response 1510. In another example, if security event log 220 indicates a remediation task was performed with respect to the event and no further exposure has occurred, failure detector 214 can determine the security event is remediated. If security event log 220 indicates the remediation task was performed or further exposure/activity of the security event is occurring, failure detector 214 determines the security event is not remediated and failure is detected. If the first candidate remediated the first security event, flowchart 1600 continues to step 1610. Otherwise, flowchart 1600 continues to step 1612.

In step 1610, the first security event is marked as a resolved security event. For example, failure detector 214, responsive to determining the security event has been remediated, marks the security event as remediated. In an embodiment, failure detector 214 causes a notification to be transmitted to candidate 226 or their computing device indicating the security event has been remediated. In another embodiment, failure detector 214 removes the security event from a table or ledger of active security events.

In step 1612, a mitigation step is caused to be performed. For example, as shown in FIG. 15, mitigator 216 causes a mitigation step to be performed. Example mitigation steps include, but are not limited to, causing reminder 248A to be transmitted to a candidate computing device (e.g., as described with respect to FIG. 4A), causing a new remediation task to be generated (e.g., as described with respect to FIG. 4B), causing a new candidate to be selected (e.g., as described with respect to FIG. 4C), and/or other mitigation steps described herein.

### III. Further Example Embodiments

### A. Automatic Tagging Embodiments

In some aspects, monitoring agent 122 post-processes determinations of whether or not a candidate or task was successful in remediating a security event. For instance, in an aspect, monitoring agent 122 tags a candidate with information corresponding to the security event. The tag can indicate a type of the security event, tasks performed for remediating the security event, resources impacted by the security event, and/or other information related to the security event. Candidate search agent 118 can utilize the tags for searching for candidates to remediate security events. Systems comprising candidate search agent 118 and monitoring agent 122 that generate and utilize tags can operate in various ways, in embodiments. For example, FIG. 17 shows a flowchart 1700 of a process for automatically tagging a candidate, in accordance with an example embodiment. In an embodiment, candidate search agent 118 and monitoring agent 122 of FIG. 2 operate according to one or more steps of flowchart 1700. Note not all steps of flowchart 1700 need be performed in all embodiments. Further structural and operational embodiments will be apparent to persons skilled in the relevant art(s) based on the following description of FIG. 17 with respect to FIG. 2.

Flowchart 1700 begins with step 1702. In step 1702, a first tag corresponding to the first security event is determined. For instance, monitoring agent 122 or another component of task assignment manager 116 (e.g., a tagging agent that performs operations with respect to tagging security events and/or candidate profiles) determines a tag 264 corresponding to a security event. Tag 264 can indicate a variety of information such as, but not limited to, an attack type of a cyber-attack associated with the security event, a type of resource impacted by the security event, a threat level associated with the security event indicating a potential risk of exposing sensitive data, a candidate identifier of candidate 226, and/or other information that a record of a security event could be tagged with. In an embodiment, monitoring agent 122 updates security log 220 to include tag 264.

In step 1704, the first tag is associated with the first candidate. For example, suppose tag 264 is not associated with candidate 226 prior to task assignor 210 assigning remediation task 236 to candidate 226. In this example, monitoring agent 122 or another component associates tag 264 with a candidate profile of candidate 226. In an embodiment where candidate 226 successfully remediated the security event tagged with tag 264, monitoring agent 122 associates tag 264 with the candidate profile of candidate 226. In this context, the association of tag 264 indicates that candidate 226 has previously handled security events associated with the tag.

In some embodiments, monitoring agent 122 or another component associates tags with candidate profiles in a negative relationship. For instance, suppose candidate 226 was unsuccessful in remediating the security event or indicated they were unable to perform the remediation task. In this context, monitoring agent 122 or the other component can associate the tag with a negative relationship to the candidate profile of candidate 226. By tagging profiles in this manner, monitoring agent 122 reduces the likelihood of or prevents assignment of security events with the tag. For instance, suppose candidate 226 does not have a level of privileges needed to access a tool. Further suppose in this example tag 264 indicates the tool is utilized to mitigate the security event. In this context, monitoring agent 122 can tag the candidate profile of candidate 226 with a tag indicating candidate 226 is unable to access the tool, thereby preventing similar remediation tasks from being assigned to candidate 226.

In step 1706, information related to a second security event with respect to the computing network is received. For example, candidate selector 202 receives information related to a second security event, e.g., in manners described elsewhere herein such as with respect to step 302 of flowchart 300 of FIG. 3.

In step 1708, a second tag corresponding to the second security event is determined. For example, candidate selector 202 determines a tag corresponding to the second security event, e.g., utilizing similar techniques as monitoring agent 122 or causing a tagging agent (not shown in FIG. 2) to generate the tag. In an embodiment, a database of tags are maintained and semantic embeddings representative of the tags are associated therewith. In this context, a tagging agent or other component can determine which tags to associate with a security event by generating or otherwise obtaining embeddings that semantically represent the security event and determining if a level of similarity between the embeddings of the tag and the embeddings of the security event satisfies a similarity criterion. In embodiments, a security event can be tagged with multiple tags.

In step 1710, the second tag is determined to match the first tag. For example, candidate selector 202 of FIG. 2 determines the tag determined in step 1708 matches the tag determined in step 1702, e.g., tag 264. In this context, candidate selector 202 can consider the tag in determining whether or not to select the associated candidate. For instance, candidate selector 202 can select or increase the rank of a candidate if the tags match. In an alternative embodiment where the tag is negatively associated with the candidate, candidate selector 202 prevents selection of or reduces the rank of the candidate.

### B. Automatic Remediation Embodiments

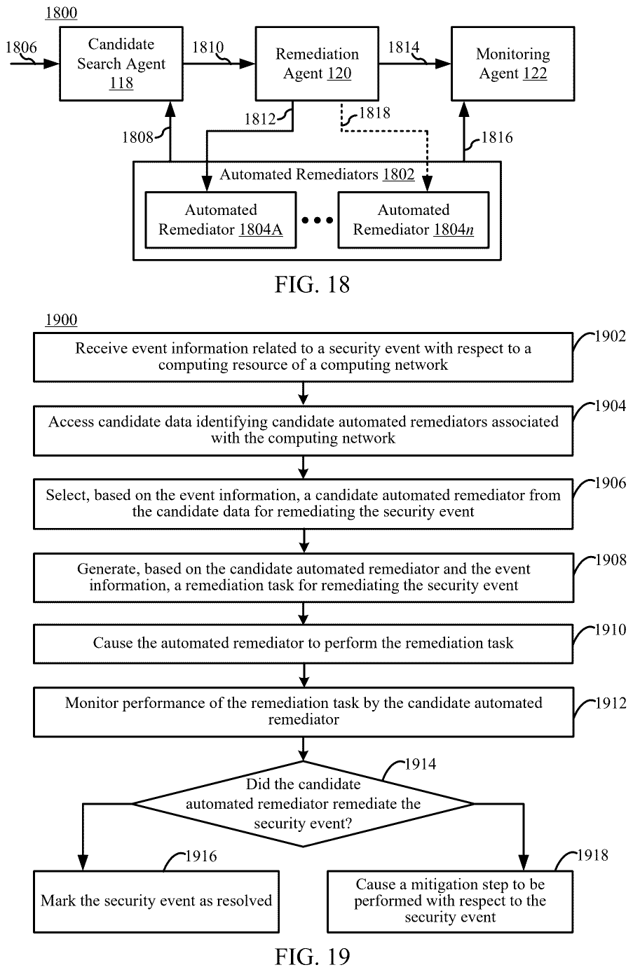

Embodiments have been described herein with respect to selecting candidate users for remediating security events. However, it is also contemplated herein that embodiments of task assignment managers and their respective agents can assign tasks to and monitor performance of tasks by automated components or services, also referred to as “automated remediators.” Systems manage assignment to and monitor automated remediators in various ways, in embodiments. For example, FIG. 18 shows a block diagram of a system 1800 for remediating security events utilizing automated remediators, in accordance with an embodiment. As shown in FIG. 18, system 1800 comprises candidate search agent 118, remediation agent 120, and monitoring agent 122, as described with respect to FIG. 1, as well as a plurality of automated remediators 1802. Automated remediators 1802 comprise one or more devices and or services executed by devices that automatically perform tasks. Examples of automated remediators include, but are not limited to: automated update services that automatically deploy patches or other updates for software and/or firmware; an access prevention system such as a firewall that automatically blocks unauthorized access to resources; an identity management system that can automatically reset or otherwise manage credentials; a certificate management system that can automatically revoke, rotate, or otherwise manage certificates; a network access management system that can automatically block or redirect network communications; and/or other automated systems that can automatically perform tasks for remediating security events. As shown in FIG. 18, automated remediators 1802 comprise automated remediators 1804A-1804n; however, automated remediators 1802 can include any number of automated remediators (e.g., ones, tens, hundreds, thousands, or even greater numbers). Automated remediators 1804A-1804n can be distributed across multiple devices within a networked system (e.g., a cloud computing system or an enterprise network system). In an embodiment, one or more automated remediators are located external to the networked system. For instance, an automated remediator in such an example can be an update service of a third party application that can be accessed by a computing device within the networked system for updating an instance of the third party application executed within the networked system.

To better understand the operation of system 1800, FIG. 18 is described with respect to FIG. 19. FIG. 19 shows a flowchart 1900 of a process for remediating security events utilizing automated remediators, in accordance with an embodiment. In an embodiment, candidate search agent 118, remediation agent 120, and monitoring agent 122 of FIG. 18 operate according to one or more steps of flowchart 1800. Note not all steps of flowchart 1900 need be performed in all embodiments. Further structural and operational embodiments will be apparent to persons skilled in the relevant art(s) based on the following descriptions of FIGS. 18 and 19.

Flowchart 1900 begins with step 1902. In step 1902, event information related to a security event with respect to a computing resource of a computing network is received. For example, candidate search agent 118 of FIG. 18 receives event information 1806 related to a security event, e.g., in a similar manner as event information 222 is received in step 302 of flowchart 300 of FIG. 3.

In step 1904, candidate data identifying candidate automated remediators associated with the computing network is accessed. For example, candidate search agent 118 of FIG. 18 identifies candidate automated remediators 1808 of automated remediators 1804A-1804n. Candidate search agent 118 can access candidate data of the automated remediators stored in a database in a similar manner as candidate data 134 is accessed in step 304 of flowchart 300 of FIG. 3.

In step 1906, a candidate automated remediator is selected, based on the event information, from among the candidate data for remediating the security event. For example, candidate search agent 118 of FIG. 18 selects candidate 1810 based on event information 1806 from among candidate automated remediators 1808. In an embodiment, candidate search agent 118 makes the selection utilizing techniques described elsewhere herein. For instance, candidate search agent 118 can select candidate 1810 based on tags of candidate data of candidate 1810 and tags of event information 1806, a semantic similarity between candidate 1810 and event information 1806, an availability of candidate 1810 to remediate the security event, a level of access granted to the security event.

In step 1908, a remediation task for remediating the security event is generated based on the candidate automated remediator and the event information. For example, remediation agent 120 of FIG. 18 generates a remediation task 1812 in a similar manner as described with respect to step 308 of flowchart 300 of FIG. 3, as well as elsewhere herein. In embodiments, remediation task 1812 comprises instructions that cause candidate 1810 to automatically perform the task.

In step 1910, the automated remediator is caused to perform the remediation task. For example, suppose automated remediator 1804A is selected candidate 1810. In this context, remediation agent 120 of FIG. 18 provides remediation task 1812 to automated remediator 1804A, causing automated remediator 1804A to attempt to perform the task or queue the task.

In step 1912, performance of the remediation task by the candidate automated remediator is monitored. For example, monitoring agent 122 of FIG. 18 receives an assignment signal 1814 from remediation agent 120 indicating remediation task 1812 has been assigned to automated remediator 1804A. Monitoring agent 122 monitors logs of the security event or automated remediator 1804A. For instance, in an embodiment shown in FIG. 18, monitoring agent 122 receives log signals 1816 representative of activity of automated remediator 1804A.

In step 1914, a determination of whether or not the automated remediator remediated the security event is made. For example, monitoring agent 122 of FIG. 18 determines whether or not automated remediator 1804A successfully remediated the security event based. Monitoring agent 122 can make this determination in similar manners as described with respect to step 314 of flowchart 300 of FIG. 3, as well as elsewhere herein. If security event was successfully remediated, flowchart 1900 continues to step 1916. Otherwise, flowchart 1900 continues to step 1918.

In step 1916, the security event is marked as resolved. For example, monitoring agent 122 of FIG. 18 marks a security event as resolved in a similar manner as described with respect to step 1610 of flowchart 1600 of FIG. 16.

In step 1918, a mitigation step is caused to be performed with respect to the security event. For example, monitoring agent 122 of FIG. 18 causes a mitigation step to be performed in a similar manner as described with respect to step 1612 of flowchart 1600 of FIG. 16, as well as elsewhere herein. For instance, monitoring agent 122 can cause a reminder or re-scheduling of remediation task 1812 to automated remediator 1804A. In another example, monitoring agent 122 causes a new remediation task to be generated and assigned to automated remediator 1804A. In another example, monitoring agent 122 causes candidate search agent 118 to select another candidate for remediating the security event, e.g., automated remediator 1804n. For instance, as shown in FIG. 18, remediation agent 120 optionally schedules a remediation task 1818 to automated remediator 1804n.

### C. Other Task Assignment Embodiments

Embodiments have been described herein with respect to determining candidates to remediate a security event, generating tasks to remediate the security event, and monitoring performance of the tasks by the candidates. However, embodiments described herein can also be utilized within implementations other than security event mitigation. For instance, in an alternative embodiment, a candidate is selected for working on a project within an organization, a task for performing some or all of operations with respect to the project is generated, and performance of the tasks to complete the project is monitored. In another alternative embodiment, an automated remediator is selected for handling a workload (e.g., a query workload or other type of workload), a task for performing some or all of the workload is generated, and performance of the tasks to complete the workload is monitored.

### D. Candidate Data Enhancement Embodiments

Embodiments of the present disclosure have been described with respect to accessing candidate data in order to select a candidate for remediating a task. In some situations, candidate data for one or more candidates can be incomplete. For instance, a candidate could not be assigned to a team or grouping of candidates, missing a label, have incomplete tagging information, and/or the like. In some implementations, embodiments of the present disclosure utilize few-shot learning or retrieval-augmented generation (RAG) techniques to enhance existing candidate data with additional information. As a non-limiting example, suppose the following data shown in Table 1 represents candidates within a tenant of a cloud computing or enterprise network system:

TABLE 1

| Index | TenantID | Label | ID | Name | Owner(s) |
|---|---|---|---|---|---|
| 1 | 222345e7 | org/storageaccounts | 88xdf7 | wac-2ed | {“owners”:“CORE-TEAM”} |
| 2 | 345123f8 | org/virtualmachines | 99dss2 | mx-app | {“Owner”:“Eric A.”} |
| 3 | abc123f8 | org/virtualmachines | d94fc2 | glmd2e | {“APP_Owner”:“Hill”} |
| 4 | defjk1238 | org/storageaccounts | c923c3 | ADLV | |
| 5 | 987yuio22 | org/virtualmachines | ex4c29 | kro3ev | |

As shown in Table 1, candidate data for candidates at indexes 1-3 are complete, but candidate data for candidates at index 4 and 5 are missing owner information. In an embodiment, candidate search agent 118 (or another component of a task assignment manager) can leverage a generative AI model (such as candidate selection model 128) to generate potential owner information to include in the candidate data. In this example, candidate search agent 118 generates a prompt comprising information at indexes 1-3 as examples (also referred to as “few shots”), the known information at indexes 4 and 5 as input, and a request to generate or otherwise identify owners for indexes 4 and 5 utilizing the known information as input and utilizing the information of indexes 1-3 as example outputs. The prompt causes the generative AI model to generate owners for indexes 4 and 5 using indexes 1-3 as examples. In an aspect, generative AI model locates where owners for indexes 1-3 are indicated in data accessible to the model and searches in similar locations for ownership data for indexes 4 and 5. By correlating and generating additional candidate data in this manner, such embodiments are able to enhance candidate data evaluated for selection of candidates, thereby improving candidate selection.

### IV. Example Computer System Implementation

Systems, devices, components, and/or techniques described herein are implemented in hardware, or hardware combined with one or both of software and/or firmware. For example, task assignment manager 116, candidate search agent 118, remediation agent 120, monitoring agent 122, application 126, candidate selection model 128, task generation model 130, mitigation model 132, candidate selector 202, candidate validator 204, acknowledgement sub-agent 206, task generator 208, task assignor 210, task monitor 212, failure detector 214, mitigator 216, candidate search sub-model 502, embeddings sub-model 504, UI manager 1002, UI 1004, potential task generation sub-model 1006, task evaluation sub-model 1008, embeddings sub-model 1028, status check sub-model 1502, mitigation step generation sub-model 1504, and/or automated remediators 1802, and/or each of the components described therein, and/or the steps of flowcharts 300, 400A, 400B, 400C, 600, 700, 800, 900, 1100, 1200, 1300, 1400, 1600, 1700, and/or 1900 are each implemented as computer program code/instructions configured to be executed in one or more processors and stored in a computer readable storage medium. Alternatively, security detection system 102, model training system 114, task assignment manager 116, candidate search agent 118, remediation agent 120, monitoring agent 122, candidate selection model 128, task generation model 130, mitigation model 132, candidate selector 202, candidate validator 204, acknowledgement sub-agent 206, task generator 208, task assignor 210, task monitor 212, failure detector 214, mitigator 216, candidate search sub-model 502, embeddings sub-model 504, UI manager 1002, potential task generation sub-model 1006, task evaluation sub-model 1008, embeddings sub-model 1028, status check sub-model 1502, mitigation step generation sub-model 1504, and/or automated remediators 1802 and/or each of the components described therein, and/or the steps of flowcharts 300, 400A, 400B, 400C, 600, 700, 800, 900, 1100, 1200, 1300, 1400, 1600, 1700, and/or 1900 are each implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

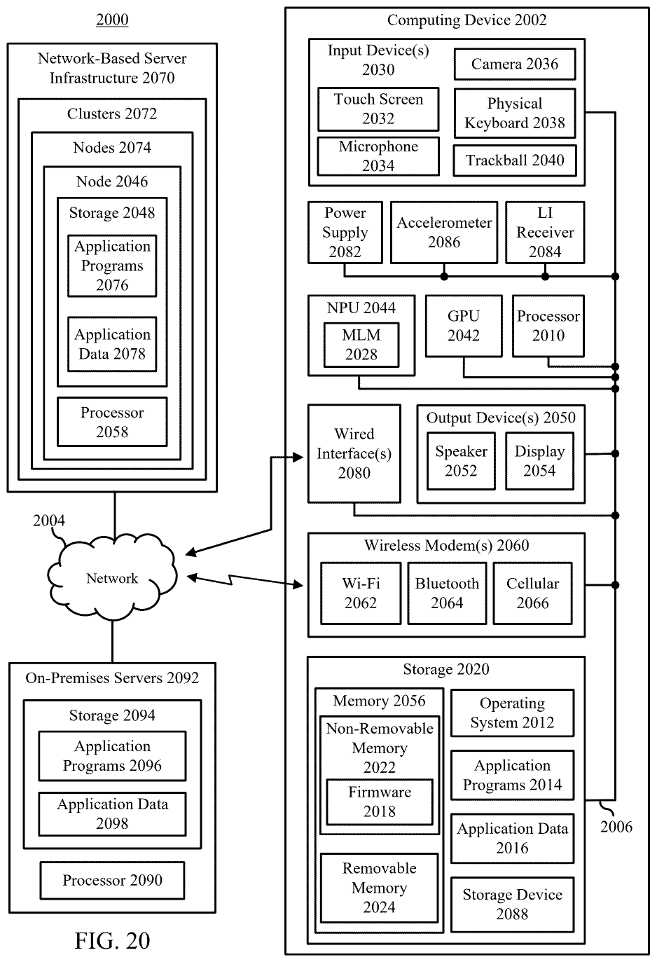

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 20. FIG. 20 shows a block diagram of an exemplary computing environment 2000 that includes a computing device 2002. Computing device 2002 is an example of security detection system 102, task assignment and monitoring server 104, candidate computing device 106A, candidate computing device 106n, model server 108, computing device 110, model training system 114, automated remediators 1802, which each include one or more of the components of computing device 2002. In some embodiments, computing device 2002 is communicatively coupled with devices (not shown in FIG. 20) external to computing environment 2000 via network 2004. In accordance with an embodiment, network 2004 is an example of network 140 of FIG. 1. Network 2004 comprises one or more networks such as local area networks (LANs), wide area networks (WANs), enterprise networks, the Internet, etc. In examples, network 2004 includes one or more wired and/or wireless portions. In some examples, network 2004 additionally or alternatively includes a cellular network for cellular communications. Computing device 2002 is described in detail as follows.

Computing device 2002 can be any of a variety of types of computing devices. Examples of computing device 2002 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 2002 is a stationary computing device such as a desktop computer, a personal computer (PC), a stationary server device, a minicomputer, a mainframe, a supercomputer, etc.

As shown in FIG. 20, computing device 2002 includes a variety of hardware and software components, including a processor 2010, a storage 2020, a graphics processing unit (GPU) 2042, a neural processing unit (NPU) 2044, one or more input devices 2030, one or more output devices 2050, one or more wireless modems 2060, one or more wired interfaces 2080, a power supply 2082, a location information (LI) receiver 2084, and an accelerometer 2086. Storage 2020 includes memory 2056, which includes non-removable memory 2022 and removable memory 2024, and a storage device 2088. Storage 2020 also stores an operating system 2012, application programs 2014, and application data 2016. Wireless modem(s) 2060 include a Wi-Fi modem 2062, a Bluetooth modem 2064, and a cellular modem 2066. Output device(s) 2050 includes a speaker 2052 and a display 2054. Input device(s) 2030 includes a touch screen 2032, a microphone 2034, a camera 2036, a physical keyboard 2038, and a trackball 2040. Not all components of computing device 2002 shown in FIG. 20 are present in all embodiments, additional components not shown may be present, and in a particular embodiment any combination of the components are present. In examples, components of computing device 2002 are mounted to a circuit card (e.g., a motherboard) of computing device 2002, integrated in a housing of computing device 2002, or otherwise included in computing device 2002. The components of computing device 2002 are described as follows.

In embodiments, a single processor 2010 (e.g., central processing unit (CPU), microcontroller, a microprocessor, signal processor, ASIC (application specific integrated circuit), and/or other physical hardware processor circuit) or multiple processors 2010 are present in computing device 2002 for performing such tasks as program execution, signal coding, data processing, input/output processing, power control, and/or other functions. In examples, processor 2010 is a single-core or multi-core processor, and each processor core is single-threaded or multithreaded (to provide multiple threads of execution concurrently). Processor 2010 is configured to execute program code stored in a computer readable medium, such as program code of operating system 2012 and application programs 2014 stored in storage 2020. The program code is structured to cause processor 2010 to perform operations, including the processes/methods disclosed herein. Operating system 2012 controls the allocation and usage of the components of computing device 2002 and provides support for one or more application programs 2014 (also referred to as “applications” or “apps”). In examples, application programs 2014 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 2010 includes one or more general processors (e.g., CPUs) configured with or coupled to one or more hardware accelerators, such as one or more NPUs 2044 and/or one or more GPUs 2042.

Any component in computing device 2002 can communicate with any other component according to function, although not all connections are shown for ease of illustration. For instance, as shown in FIG. 20, bus 2006 is a multiple signal line communication medium (e.g., conductive traces in silicon, metal traces along a motherboard, wires, etc.) present to communicatively couple processor 2010 to various other components of computing device 2002, although in other embodiments, an alternative bus, further buses, and/or one or more individual signal lines is/are present to communicatively couple components. Bus 2006 represents one or more of any of several types of bus structures, including a memory bus or memory controller, a peripheral bus, an accelerated graphics port, and a processor or local bus using any of a variety of bus architectures.

Storage 2020 is physical storage that includes one or both of memory 2056 and storage device 2088, which store operating system 2012, application programs 2014, and application data 2016 according to any distribution. In an embodiment, storage 2020 is an example of data store 112 of FIG. 1. Non-removable memory 2022 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 2022 includes main memory and is separate from or fabricated in a same integrated circuit as processor 2010. As shown in FIG. 20, non-removable memory 2022 stores firmware 2018 that is present to provide low-level control of hardware. Examples of firmware 2018 include BIOS (Basic Input/Output System, such as on personal computers) and boot firmware (e.g., on smart phones). In examples, removable memory 2024 is inserted into a receptacle of or is otherwise coupled to computing device 2002 and can be removed by a user from computing device 2002. Removable memory 2024 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 2088 are present that are internal and/or external to a housing of computing device 2002 and are or are not removable. Examples of storage device 2088 include a hard disk drive, an SSD, a thumb drive (e.g., a USB (Universal Serial Bus) flash drive), or other physical storage device.

One or more programs are stored in storage 2020. Such programs include operating system 2012, one or more application programs 2014, and other program modules and program data. Examples of such application programs include computer program logic (e.g., computer program code/instructions) for implementing task assignment manager 116, candidate search agent 118, remediation agent 120, monitoring agent 122, application 126, candidate selection model 128, task generation model 130, mitigation model 132, candidate selector 202, candidate validator 204, acknowledgement sub-agent 206, task generator 208, task assignor 210, task monitor 212, failure detector 214, mitigator 216, candidate search sub-model 502, embeddings sub-model 504, UI manager 1002, UI 1004, potential task generation sub-model 1006, task evaluation sub-model 1008, embeddings sub-model 1028, status check sub-model 1502, mitigation step generation sub-model 1504, and/or automated remediators 1802, and/or each of the components described therein, and/or the steps of flowcharts 300, 400A, 400B, 400C, 600, 700, 800, 900, 1100, 1200, 1300, 1400, 1600, 1700, and/or 1900, and/or any individual steps thereof.

Storage 2020 also stores data used and/or generated by operating system 2012 and application programs 2014 as application data 2016. Examples of application data 2016 include web pages, text, images, tables, sound files, video data, and other data. In examples, application data 2016 is sent to and/or received from one or more network servers or other devices via one or more wired or wireless networks. Storage 2020 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 2002 through one or more input devices 2030 and receives information from computing device 2002 through one or more output devices 2050. Input device(s) 2030 includes one or more of touch screen 2032, microphone 2034, camera 2036, physical keyboard 2038 and/or trackball 2040 and output device(s) 2050 includes one or more of speaker 2052 and display 2054. Each of input device(s) 2030 and output device(s) 2050 are integral to computing device 2002 (e.g., built into a housing of computing device 2002) or are external to computing device 2002 (e.g., communicatively coupled wired or wirelessly to computing device 2002 via wired interface(s) 2080 and/or wireless modem(s) 2060). Further input devices 2030 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 2054 displays information, as well as operating as touch screen 2032 by receiving user commands and/or other information (e.g., by touch, finger gestures, virtual keyboard, etc.) as a user interface. Any number of each type of input device(s) 2030 and output device(s) 2050 are present, including multiple microphones 2034, multiple cameras 2036, multiple speakers 2052, and/or multiple displays 2054.

In embodiments where GPU 2042 is present, GPU 2042 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 2042 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 2044 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 2028. In an example, NPU 2044 is configured for a data-driven parallel computing and is highly efficient at processing massive multimedia data such as videos and images and processing data for neural networks. NPU 2044 is configured for efficient handling of AI-related tasks, such as speech recognition, background blurring in video calls, photo or video editing processes like object detection, etc.

In embodiments disclosed herein that implement ML models, NPU 2044 can be utilized to execute such ML models, of which MLM 2028 is an example. In an embodiment, MLM 2028 is an example of candidate selection model 128, task generation model 130, and/or mitigation model 132 of FIG. 1, and/or sub-models thereof. For instance, where applicable, MLM 2028 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 2044 is used to train MLM 2028. To train MLM 2028, training data that includes input features (attributes) and their corresponding output labels/target values (e.g., for supervised learning) is collected. A training algorithm is a computational procedure that is used so that MLM 2028 learns from the training data. Parameters/weights are internal settings of MLM 2028 that are adjusted during training by the training algorithm to reduce a difference between predictions by MLM 2028 and actual outcomes (e.g., output labels). In some examples, MLM 2028 is set with initial values for the parameters/weights. A loss function measures a dissimilarity between predictions by MLM 2028 and the target values, and the parameters/weights of MLM 2028 are adjusted to minimize the loss function. The parameters/weights are iteratively adjusted by an optimization technique, such as gradient descent. In this manner, MLM 2028 is generated through training by NPU 2044 to be used to generate inferences based on received input feature sets for particular applications. MLM 2028 is generated as a computer program or other type of algorithm configured to generate an output (e.g., a classification, a prediction/inference) based on received input features, and is stored in the form of a file or other data structure.

In examples, such training of MLM 2028 by NPU 2044 is supervised or unsupervised. According to supervised learning, input objects (e.g., a vector of predictor variables) and a desired output value (e.g., a human-labeled supervisory signal) train MLM 2028. The training data is processed, building a function that maps new data on expected output values. Example algorithms usable by NPU 2044 to perform supervised training of MLM 2028 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 2028 is an LLM, MLM 2028 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 2028 is trained to learn patterns from unlabeled data. For instance, in embodiments where MLM 2028 implements unsupervised learning techniques, MLM 2028 identifies one or more classifications or clusters to which an input belongs. During a training phase of MLM 2028 according to unsupervised learning, MLM 2028 tries to mimic the provided training data and uses the error in its mimicked output to correct itself (i.e., correct weights and biases). In further examples, NPU 2044 perform unsupervised training of MLM 2028 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 2044 need not necessarily be present in all ML model embodiments. In embodiments where ML models are present, any one or more of processor 2010, GPU 2042, and/or NPU 2044 can be present to train and/or execute MLM 2028.

One or more wireless modems 2060 can be coupled to antenna(s) (not shown) of computing device 2002 and can support two-way communications between processor 2010 and devices external to computing device 2002 through network 2004, as would be understood to persons skilled in the relevant art(s). Wireless modem 2060 is shown generically and can include a cellular modem 2066 for communicating with one or more cellular networks, such as a GSM network for data and voice communications within a single cellular network, between cellular networks, or between the mobile device and a public switched telephone network (PSTN). In examples, wireless modem 2060 also or alternatively includes other radio-based modem types, such as a Bluetooth modem 2064 (also referred to as a “Bluetooth device”) and/or Wi-Fi modem 2062 (also referred to as an “wireless adaptor”). Wi-Fi modem 2062 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 2064 is configured to communicate with another Bluetooth-capable device according to the Bluetooth short-range wireless technology standard(s) such as IEEE 802.20.1 and/or managed by the Bluetooth Special Interest Group (SIG).

Computing device 2002 can further include power supply 2082, LI receiver 2084, accelerometer 2086, and/or one or more wired interfaces 2080. Example wired interfaces 2080 include a USB port, IEEE 1394 (FireWire) port, a RS-202 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 2080 of computing device 2002 provide for wired connections between computing device 2002 and network 2004, or between computing device 2002 and one or more devices/peripherals when such devices/peripherals are external to computing device 2002 (e.g., a pointing device, display 2054, speaker 2052, camera 2036, physical keyboard 2038, etc.). Power supply 2082 is configured to supply power to each of the components of computing device 2002 and receives power from a battery internal to computing device 2002, and/or from a power cord plugged into a power port of computing device 2002 (e.g., a USB port, an A/C power port). LI receiver 2084 is useable for location determination of computing device 2002 and in examples includes a satellite navigation receiver such as a Global Positioning System (GPS) receiver and/or includes other type of location determiner configured to determine location of computing device 2002 based on received information (e.g., using cell tower triangulation, etc.). Accelerometer 2086, when present, is configured to determine an orientation of computing device 2002.

Note that the illustrated components of computing device 2002 are not required or all-inclusive, and fewer or greater numbers of components can be present as would be recognized by one skilled in the art. In examples, computing device 2002 includes one or more of a gyroscope, barometer, proximity sensor, ambient light sensor, digital compass, etc. In an example, processor 2010 and memory 2056 are co-located in a same semiconductor device package, such as being included together in an integrated circuit chip, FPGA, or system-on-chip (SOC), optionally along with further components of computing device 2002.

In embodiments, computing device 2002 is configured to implement any of the above-described features of flowcharts herein. Computer program logic for performing any of the operations, steps, and/or functions described herein is stored in storage 2020 and executed by processor 2010.

In some embodiments, server infrastructure 2070 is present in computing environment 2000 and is communicatively coupled with computing device 2002 via network 2004. Server infrastructure 2070, when present, is a network-accessible server set (e.g., a cloud-based environment or platform). As shown in FIG. 20, server infrastructure 2070 includes clusters 2072. Each of clusters 2072 comprises a group of one or more compute nodes and/or a group of one or more storage nodes. For example, as shown in FIG. 20, cluster 2072 includes nodes 2074. Each of nodes 2074 are accessible via network 2004 (e.g., in a “cloud-based” embodiment) to build, deploy, and manage applications and services. In examples, any of nodes 2074 is a storage node that comprises a plurality of physical storage disks, SSDs, and/or other physical storage devices that are accessible via network 2004 and are configured to store data associated with the applications and services managed by nodes 2074.

Each of nodes 2074, as a compute node, comprises one or more server computers, server systems, and/or computing devices. For instance, a node 2074 in accordance with an embodiment includes one or more of the components of computing device 2002 disclosed herein. Each of nodes 2074 is configured to execute one or more software applications (or “applications”) and/or services and/or manage hardware resources (e.g., processors, memory, etc.), which are utilized by users (e.g., customers) of the network-accessible server set. In examples, as shown in FIG. 20, nodes 2074 includes a node 2046 that includes storage 2048 and/or one or more of a processor 2058 (e.g., similar to processor 2010, GPU 2042, and/or NPU 2044 of computing device 2002). Storage 2048 stores application programs 2076 and application data 2078. Processor(s) 2058 operate application programs 2076 which access and/or generate related application data 2078. In an implementation, nodes such as node 2046 of nodes 2074 operate or comprise one or more virtual machines, with each virtual machine emulating a system architecture (e.g., an operating system), in an isolated manner, upon which applications such as application programs 2076 are executed.

In embodiments, one or more of clusters 2072 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 2072 are included in a datacenter in a distributed collection of datacenters. In embodiments, exemplary computing environment 2000 comprises part of a cloud-based platform.

In an embodiment, computing device 2002 accesses application programs 2076 for execution in any manner, such as by a client application and/or a browser at computing device 2002.

In an example, for purposes of network (e.g., cloud) backup and data security, computing device 2002 additionally and/or alternatively synchronizes copies of application programs 2014 and/or application data 2016 to be stored at network-based server infrastructure 2070 as application programs 2076 and/or application data 2078. In examples, operating system 2012 and/or application programs 2014 include a file hosting service client configured to synchronize applications and/or data stored in storage 2020 at network-based server infrastructure 2070.

In some embodiments, on-premises servers 2092 are present in computing environment 2000 and are communicatively coupled with computing device 2002 via network 2004. On-premises servers 2092, when present, are hosted within an organization's infrastructure and, in many cases, physically onsite of a facility of that organization. On-premises servers 2092 are controlled, administered, and maintained by IT (Information Technology) personnel of the organization or an IT partner to the organization. Application data 2098 can be shared by on-premises servers 2092 between computing devices of the organization, including computing device 2002 (when part of an organization) through a local network of the organization, and/or through further networks accessible to the organization (including the Internet). Furthermore, in examples, on-premises servers 2092 serve applications such as application programs 2096 to the computing devices of the organization, including computing device 2002. Accordingly, in examples, on-premises servers 2092 include storage 2094 (which includes one or more physical storage devices such as storage disks and/or SSDs) for storage of application programs 2096 and application data 2098 and include a processor 2090 (e.g., similar to processor 2010, GPU 2042, and/or NPU 2044 of computing device 2002) for execution of application programs 2096. In some embodiments, multiple processors 2090 are present for execution of application programs 2096 and/or for other purposes. In further examples, computing device 2002 is configured to synchronize copies of application programs 2014 and/or application data 2016 for backup storage at on-premises servers 2092 as application programs 2096 and/or application data 2098.

Embodiments described herein may be implemented in one or more of computing device 2002, network-based server infrastructure 2070, and on-premises servers 2092. For example, in some embodiments, computing device 2002 is used to implement systems, clients, or devices, or components/subcomponents thereof, disclosed elsewhere herein. In other embodiments, a combination of computing device 2002, network-based server infrastructure 2070, and/or on-premises servers 2092 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 2020. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 2014) are stored in storage 2020. Such computer programs can also be received via wired interface(s) 2060 and/or wireless modem(s) 2060 over network 2004. Such computer programs, when executed or loaded by an application, enable computing device 2002 to implement features of embodiments discussed herein. Accordingly, such computer programs represent controllers of the computing device 2002.

Embodiments are also directed to computer program products comprising computer code or instructions stored on any computer-readable medium or computer-readable storage medium. Such computer program products include the physical storage of storage 2020 as well as further physical storage types.

### IX. Additional Exemplary Embodiments

A method is described herein. The method comprises a first process, a second process, and/or a third process.

In a further example of the foregoing method, the first process comprises: receiving first event information related to a first security event with respect to a computing resource of a computing network; accessing candidate data identifying candidates associated with the computing network; and selecting, based on the first event information, a first candidate from the candidate data for remediating the first security event.

In a further example of the foregoing method, the second process comprises: generating, based on the first candidate and the first event information, a first remediation task for remediating the first security event; and assigning the first remediation task to the first candidate.

In a further example of the foregoing method, the third process comprises: monitoring performance of the remediation task by the first candidate; and determining whether or not the first candidate has failed to remediate the first security event.

In a further example of the foregoing method, the first process is performed by a candidate search agent.

In a further example of the foregoing method, the second process is performed by a remediation agent.

In a further example of the foregoing method, the third process is performed by a monitoring agent.

In a further example of the foregoing method, the method further comprises, by the candidate search agent, utilizing a first generative AI model to select the first candidate. The first generative AI model is trained on a corpus of event information and candidate data to select candidates for remediating a security event.

In a further example of the foregoing method, the method further comprises, by the remediation agent, utilizing a second generative AI model to generate the first remediation task. The second generative AI model is trained on a corpus of first task data to generate remediation tasks for remediating security events.

In a further example of the foregoing method, the method further comprises, by the monitoring agent, utilizing a third generative AI model to determine a candidate has failed to remediate the security event. The third generative AI model is trained on a corpus of event information, candidate data, and task data to detect failure in remediating security events.

In a further example of the foregoing method, the candidate search agent, the remediation agent, and the monitoring agent leverage the same generative AI model to perform one or more of their operations.

In a further example of the foregoing method, selecting the first candidate comprises: utilizing an embedding model to generate first event embeddings that semantically describe the first security event, receiving second event embeddings that semantically describe a second security event, the second security event being an event previously remediated by the first candidate; and determining a level of similarity between the first event embeddings and the second event embeddings satisfies a similarity criterion.

In a further example of the foregoing method, receiving the second event embeddings further comprises: identifying the second security event in the candidate data; in response to identification of the second security event, retrieving a portion of the candidate data describing the second security event; and utilizing the embedding model to generate the second event embeddings based on the portion of the candidate data.

In a further example of the foregoing method, the method further comprises, by the candidate search agent: generating a prompt comprising the information related to the first security event and specifying the candidate data, the prompt comprising instructions to access the candidate data and select a candidate for remediating the first security event; providing the prompt to the first generative AI model; and receiving a selection of the first candidate from the first generative AI model.

In a further example of the foregoing method, determining the first candidate has failed to remediate the first security event further comprises: accessing a security log comprising a record of actions performed with respect to the first security event; and determining, based on the security log, the first candidate has failed to remediate the first security event.

In a further example of the foregoing method, causing the mitigation step to be performed comprises: causing a reminder alert to be transmitted to a computing device of the first candidate, the reminder alert specifying the first security event has not been remediated.

In a further example of the foregoing method, causing the mitigation step to be performed comprises: causing the candidate search agent to select a second candidate for remediating the first security event; and causing the remediation agent to utilize the first generative AI model to generate, based on the second candidate and the first security event, a second remediation task for remediating the first security event and assign the second remediation task to the second candidate.

In a further example of the foregoing method, causing the mitigation step to be performed comprises: causing the remediation agent to: utilize the second generative AI model to generate a second remediation task based on the first candidate, the first security event, and the determination that the first candidate has failed to remediate the first security event; and assigning the second remediation task to the first candidate.

In a further example of the foregoing method, determining the first candidate has failed to remediate the first security event comprises further comprises: determining the first remediation task was performed; and detecting a persistence of the first security event, wherein the second generative AI model generates the second remediation task based on the determination that the first remediation task was performed and the first security event persists.

In a further example of the foregoing method, selecting the first candidate comprises: selecting a second candidate from the plurality of candidates for remediating the first security event; determining the second candidate is an invalid selection based on a number of tasks in a task queue of the second candidate satisfying an invalidation criterion; selecting the first candidate from the plurality of candidates subsequent to the determination that the second candidate is an invalid selection; and determining the first candidate is a valid selection.

In a further example of the foregoing method, generating the first remediation task further comprises: identifying a plurality of tools accessible to the first candidate; and causing the second generative AI model to generate the first remediation task based on the plurality of tools, the first remediation task comprising a step utilizing at least one of the plurality of tools.

A system is described herein. The system comprises a processor and a memory. The memory stores program code executable by the processor to perform any of the foregoing methods.

In a further example of the foregoing system, the program code comprises the candidate search agent, the remediation agent, and/or the monitoring agent.

In a further example of the foregoing system, the program code comprises a tagging agent.

In a further example of the foregoing system, the program code comprises the first generative AI model, the second generative AI model, and/or the third generative AI model.

A computer-readable storage medium encoded with program instructions that, when executed by a processor circuit, perform any of the foregoing methods described herein.

### X. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, applications, task assignment managers, generative AI models, model training systems, and/or their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A task assignment system comprising:
a processor; and
a memory that stores program code executable by the processor, the program code comprising:
a candidate search agent that:
receives information related to a first with respect to a computing resource of a computing network,
access candidate data identifying candidates associated with the computing network, and
selects a first candidate from the candidate data for remediating the first security event,
a remediation agent comprising a first generative artificial intelligence (AI) model trained on a corpus of first task data to generate remediation tasks for remediating security events, the remediation agent:
utilizes the first generative AI model to generate, based on the first candidate and the first security event, a first remediation task for remediating the first security event, and
assigns the first remediation task to the first candidate, and
a monitoring agent that:
monitors performance of the first remediation task by the first candidate,
determines the first candidate has failed to remediate the first security event, and
in response to the determination that the first candidate has failed to remediate the first security event, causes a mitigation step to be performed with respect to the first security event.

2. The task assignment system of claim 1, wherein to select the first candidate, the candidate search agent further:
utilizes an embedding model to generate first event embeddings that semantically describe the first security event;
receives second event embeddings that semantically describe a second security event, the second security event being an event previously remediated by the first candidate; and
determines a level of similarity between the first event embeddings and the second event embeddings satisfies a similarity criterion.

3. The task assignment system of claim 2, wherein to receive the second event embeddings, the candidate search agent further:
identifies the second security event in the candidate data;
in response to identification of the second security event, retrieves a portion of the candidate data describing the second security event; and
utilizes the embedding model to generate the second event embeddings based on the portion of the candidate data.

4. The task assignment system of claim 1, wherein the candidate search agent comprises a second generative AI model trained on a corpus of the candidate data and event data to select candidates for remediating security events, and wherein to access candidate data and to select the first candidate, the candidate search agent further:
generates a prompt comprising the information related to the first security event and specifying the candidate data, the prompt comprising instructions to access the candidate data and select a candidate for remediating the first security event;
provides the prompt to the second generative AI model; and
receives a selection of the first candidate from the second generative AI model.

5. The task assignment system of claim 1, wherein to determine the first candidate has failed to remediate the first security event, the monitoring agent further:
accesses a security log comprising a record of actions performed with respect to the first security event; and
determines, based on the security log, the first candidate has failed to remediate the first security event.

6. The task assignment system of claim 1, wherein to cause the mitigation step to be performed, the monitoring agent further:
causes a reminder alert to be transmitted to a computing device of the first candidate, the reminder alert specifying the first security event has not been remediated.

7. The task assignment system of claim 1, wherein to cause the mitigation step to be performed, the monitoring agent further:
causes the candidate search agent to select a second candidate for remediating the first security event; and
causes the remediation agent to:
utilize the first generative AI model to generate, based on the second candidate and the first security event, a second remediation task for remediating the first security event; and
assign the second remediation task to the second candidate.

8. The task assignment system of claim 1, wherein to cause the mitigation step to be performed, the monitoring agent further:
causes the remediation agent to:
utilize the first generative AI model to generate a second remediation task based on the first candidate, the first security event, and the determination that the first candidate has failed to remediate the first security event; and
assigning the second remediation task to the first candidate.

9. The task assignment system of claim 8, wherein to determine the first candidate has failed to remediate the first security event comprises, the monitoring agent further:
determines the first remediation task was performed; and
detects a persistence of the first security event,
wherein the first generative AI model generates the second remediation task based on the determination that the first remediation task was performed and the first security event persists.

10. The task assignment system of claim 1, wherein to select the first candidate, the candidate search agent further:
selects a second candidate from the plurality of candidates for remediating the first security event;
determines the second candidate is an invalid selection based on a number of tasks in a task queue of the second candidate satisfying an invalidation criterion;
selects the first candidate from the plurality of candidates subsequent to the determination that the second candidate is an invalid selection; and
determines the first candidate is a valid selection.

11. The task assignment system of claim 1, wherein the first candidate is an automated remediation component and the first remediation task comprises instructions that cause the automated remediation component to automatically attempt to remediate the first security event.

12. A method performed by a computer-implemented task assignment manager comprising a remediation agent and a monitoring agent, the method comprising:
by the remediation agent:
receiving event information specifying a first security event and candidate information specifying a first candidate selected for remediating the first security event;
generating a first prompt based on the candidate information and the event information, the prompt specifying at least one of a level of access of the first candidate, a role of the first candidate, or a second security event previously remediated by the first candidate,
causing a generative artificial intelligence (AI) model to generate a first remediation task based on the first prompt, and
assigning the first remediation task to the first candidate; and
by the monitoring agent:
accessing a data store to obtain a log specifying activity of the first candidate,
determining, based on the log, the first candidate has failed to remediate the first security event, and
in response to said determining the first candidate has failed to remediate the first security event, causing a mitigation step to be performed.

13. The method of claim 12, wherein said determining the first candidate has failed to remediate the first security event comprises:
accessing a security log comprising a record of actions performed with respect to the first security event; and
determining, based on the security log, the first candidate has failed to remediate the first security event.

14. The method of claim 12, wherein said causing the mitigation step to be performed further comprises:
transmitting a reminder alert to a computing device corresponding to the first candidate, the reminder alert specifying the first security event has not been remediated.

15. The method of claim 12, wherein said causing the mitigation step to be performed further comprises:
causing a candidate search agent to select a second candidate for remediating the first security event; and
causing the remediation agent to:
generate, based on the second candidate and the first security event, a second remediation task for remediating the first security event, and
assign the second remediation task to the second candidate.

16. The method of claim 12, wherein said causing the mitigation step to be performed comprises:
determining the first remediation task was performed;
detecting a persistence of the first security event; and
causing the remediation agent to:
generate a second remediation task based on the first candidate, the first security event, and that performance of the first remediation task failed to remediate the first security event, and
assign the second remediation task to the first candidate.

17. The method of claim 12, wherein the first candidate is an automated remediation component, the first remediation task comprises instructions for remediating the first security event, and said assigning the first remediation task to the first candidate further comprises:
transmitting the instructions to the automated remediation component, the transmitting causing the automated remediation component to automatically attempt to remediate the first security event.

18. A computer-readable storage medium with program instructions encoded thereon, the program instructions structured to cause a processor to perform operations, the program instructions comprising:
a candidate selection agent structured to cause the processor to:
receive event information related to a first security event,
utilize an embedding model to generate, based on the event information, first event embeddings that semantically describe the first security event,
receive second event embeddings that semantically describe a second security event, the second security event being an event previously remediated by a first candidate,
determine a level of similarity between the first event embeddings and the second event embeddings satisfies a similarity criterion, and
in response to the determination of the level of similarity satisfying the similarity criterion, selects the first candidate for remediating the first security event; and
a remediation agent structured to cause the processor to:
generate, based on the first candidate and the first security event, a first remediation task for remediating the first security event; and
assign the first remediation task to the first candidate.

19. The computer-readable storage medium of claim 18, wherein the first candidate is an automated remediation component, the first remediation task comprises instructions for remediating the first security event, and wherein to assign the first remediation task to the first candidate, the remediation agent is structured to cause the processor to:
transmit the instructions to the automated remediation component, the transmitting causing the automated remediation component to automatically attempt to remediate the first security event.

20. The computer-readable storage medium of claim 18, wherein the program instructions further comprise a monitoring agent structured to cause the processor to:
obtain a log specifying activity of the first candidate;
determine, based on the log, the first candidate has failed to remediate the first security event; and
in response to the determination that the first candidate has failed to remediate the first security event, cause a mitigation step to be performed with respect to the detected failure.
